(19) United States
(12) Patent Application Publication
(10) Pub. No.: US 2011/0288884 A1
(43) Pub. Date: Nov. 24, 2011

(54) PROVIDING MEDICAL SERVICES AND/OR PRODUCTS USING TELECOMMUNICATIONS

(76) Inventors: Richard Algoo, Green Brook, NJ (US); Mary George Algoo, Green Brook, NJ (US)

(21) Appl. No.: 12/785,261

(22) Filed: May 21, 2010

(51) Int. Cl. G06Q 50/00; G06F 3/01; G06Q 99/00

(52) U.S. Cl. 705/3; 705/319; 705/2; 715/760

(57) ABSTRACT

A first web page is provided from a first server computer to a patient/consumer computer via the internet. The first web page when rendered on a patient/consumer computer display of the patient/consumer computer by an internet browser computer program running on the patient/consumer computer, may display a menu including a first set of selectable items. The first set of selectable items may include a first link which when selected using a computer interactive device of the patient/consumer computer, sends a first set of information to the first server computer, wherein the first set of information relates to setting up a first communication session between a first provider of medical services and/or goods and the patient/consumer.

### FIELD OF THE INVENTION

This invention relates to improved methods and apparatus concerning providing medical care, counseling, or education services and/or products using telecommunications.

### BACKGROUND OF THE INVENTION

There are various devices known in the prior art for providing medical care, counseling, or education services and/or products using telecommunications.

### SUMMARY OF THE INVENTION

At least one embodiment of the present invention provides a method. The method may include providing a first web page from a first server computer to a patient/consumer computer via the internet. The first web page when rendered on a patient/consumer computer display of the patient/consumer computer by an internet browser computer program running on the patient/consumer computer, may display a menu including a first set of selectable items. The first set of selectable items may include a first link which when selected using a computer interactive device of the patient/consumer computer, sends a first set of information to the first server computer, wherein the first set of information relates to setting up a first communication session between a first provider of medical services and/or goods and the patient/consumer.

The method may further include receiving the first set of information at the first server computer and causing the first communication session to be set up between the first provider of medical services and/or goods and the patient/consumer. The method may further include providing a second web page from the first server computer to the patient/consumer computer via the internet. The second web page when rendered on a patient/consumer computer display of the patient/consumer computer by an internet browser computer program running on the patient/consumer computer, may display information indicating that the patient/consumer has to wait for a period of time before having the first communication session.

The first web page when rendered on a patient/consumer computer display of the patient/consumer computer by an internet browser computer program running on the patient/consumer computer, may displays information concerning a plurality of scheduled communication sessions between the patient/consumer and a provider of medical services and/or goods, wherein each of the plurality of scheduled communication sessions is scheduled to occur at a future time. The first web page when rendered on a patient/consumer computer display of the patient/consumer computer by an internet browser computer program running on the patient/consumer computer, may display a link for accessing a web page having a patient self assessment form, into which the patient/consumer can enter information concerning characteristics of the patient/consumer. The characteristics of the patient/consumer may include the health history of the patient/consumer as recalled by the patient/consumer.

The first web page when rendered on a patient/consumer computer display of the patient/consumer computer by an internet browser computer program running on the patient/consumer computer, may display a link for accessing a web page having a provider quality survey form, into which the patient/consumer can enter information concerning the patient/consumer's opinions about the first provider of medical services and/or goods.

The method may include providing a second web page having a list of selectable providers of medical services and/or goods, and setting up the first communication session between the first provider of medical services and/or goods in response, at least in part, to a selection by the patient/consumer using the computer interactive device of the patient/consumer computer, of the first provider of medical services and/or goods from the list of selectable providers of medical services and/or goods.

The method may include providing a second web page from the first server computer to the patient/consumer computer via the internet, wherein the second web page when rendered on a patient/consumer computer display of the patient/consumer computer by an internet browser computer program running on the patient/consumer computer, provides information concerning the first communication session while the first communication session is taking place. The information concerning the first communication session while the first communication session is taking place may include video and/or text communications of the first provider of medical services and/or goods and/or video and/or text of the patient/consumer.

The method may include using the first server computer to retrieve an electronic medical record of the patient/consumer via the internet from an electronic medical record computer, and providing information concerning the electronic medical record of the patient/consumer to the first provider of medical services and/or goods.

In at least one embodiment of the present invention an apparatus is provided including a first server computer which hosts one or more web pages for a web site for setting up communication sessions between patient/consumers and one or more providers of medical services and/or goods. The first server computer may be programmed to implement one or more of the method or process steps previously mentioned.

### BRIEF DESCRIPTION OF THE DRAWINGS

FIG. 1 shows a block diagram of an apparatus in accordance with an embodiment of the present invention;

FIG. 2 shows a block diagram of a patient/consumer computer/device for use with the apparatus of FIG. 1;

FIG. 3 shows a block diagram of a provider computer/device for use with the apparatus of FIG. 1;

FIG. 4 shows a flowchart of consumer process;

FIG. 5 shows a flowchart of a provider process;

FIGS. 6A-6C show a flowchart of another consumer process;

FIG. 7 shows a flowchart of a matching engine process;

FIG. 8 shows a flowchart of another consumer process;

FIG. 9 shows a flowchart of another provider process;

FIG. 10 shows a flowchart of another consumer process;

FIG. 11 shows a flowchart of another provider process;

FIG. 12 shows a block diagram of information provided to a matching engine computer/device software program running on a server computer/device and of output recommendations provided by the matching engine;

FIG. 13 shows a first image for display on a computer/device display of the patient/consumer computer/device of FIG. 2 in accordance with an embodiment of the present invention;

FIG. 14 shows a second image for display on a computer/device display of the patient/consumer computer/device of FIG. 2 in accordance with an embodiment of the present invention;

FIG. 15 shows a third image for display on a computer/device display of the patient/consumer computer/device of FIG. 2 in accordance with an embodiment of the present invention;

FIG. 16 shows a fourth image for display on a computer/device display of the patient/consumer computer/device of FIG. 2 in accordance with an embodiment of the present invention;

FIG. 17 shows a fifth image for display on a computer/device display of the patient/consumer computer/device of FIG. 2 in accordance with an embodiment of the present invention;

FIG. 18 shows a sixth image for display on a computer/device display of the patient/consumer computer/device of FIG. 2 in accordance with an embodiment of the present invention;

FIG. 19 shows a seventh image for display on a computer/device display of the patient/consumer computer/device of FIG. 2 in accordance with an embodiment of the present invention;

FIG. 20 shows an eighth image for display on a computer/device display of the patient/consumer computer/device of FIG. 2 in accordance with an embodiment of the present invention;

FIG. 21 shows a ninth image for display on a computer/device display of the patient/consumer computer/device of FIG. 2 in accordance with an embodiment of the present invention;

FIG. 22 shows a tenth image for display on a computer/device display of the provider computer/device of FIG. 3 in accordance with an embodiment of the present invention; and

FIG. 23 shows a diagram of a dedicated computer/device in accordance with another embodiment of the present invention.

### DETAILED DESCRIPTION OF THE DRAWINGS

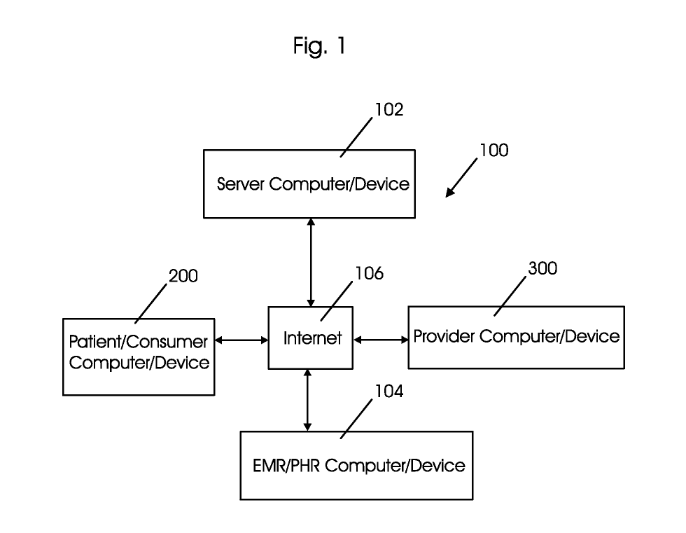

FIG. 1 shows a block diagram of an apparatus 100 in accordance with an embodiment of the present invention. The apparatus 100 includes a server computer/device 102, an EMR (electronic medical record)/personal health record (PHR) computer/device 104, a patient/consumer computer/device 200, the internet 106, and a provider computer/device 300. The server computer/device 102, the consumer computer/device 200, and the provider computer/device 300 may be connected to or in communications with the internet by communications links. The server computer/device 102 may include computer/device memory in which is stored HTML (hypertext markup language) web pages for a web site called TMED (trademarked) web site. The server computer/device 102 may be a physical device, such as a physical computer, or a virtual device which is referred to as a cloud computer in the art.

The server computer/device 102 may include a database. The server computer/device 102 may include computer/device software for receiving request for downloads of web pages of the TMED web site and may transmit web pages of the TMED web site to a requesting consumer computer/device, such as 200 or a requesting provider computer/device, such as 300. The EMR/PHR computer/device 104 may include an electronic medical record database and computer/device software related to an electronic medical record database.

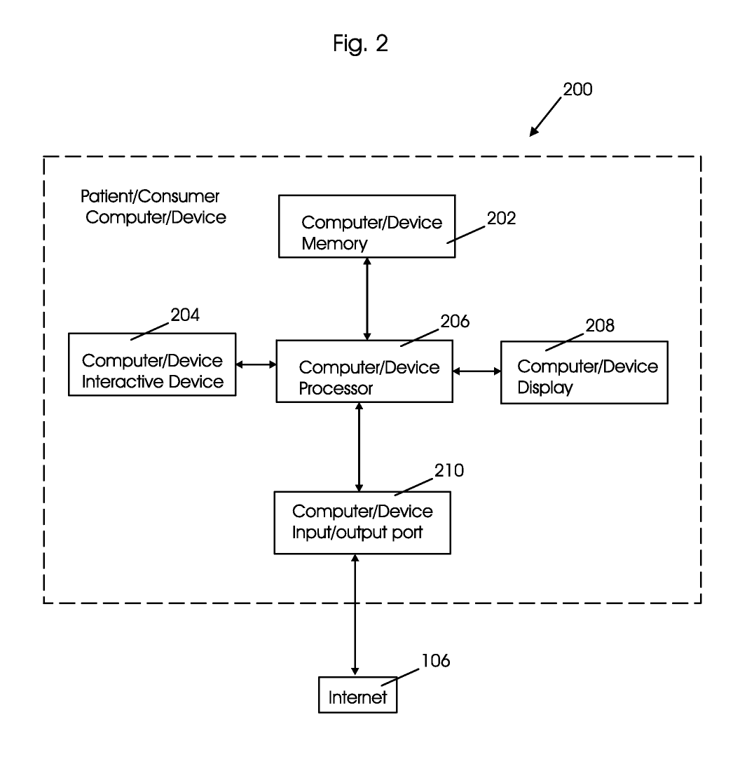

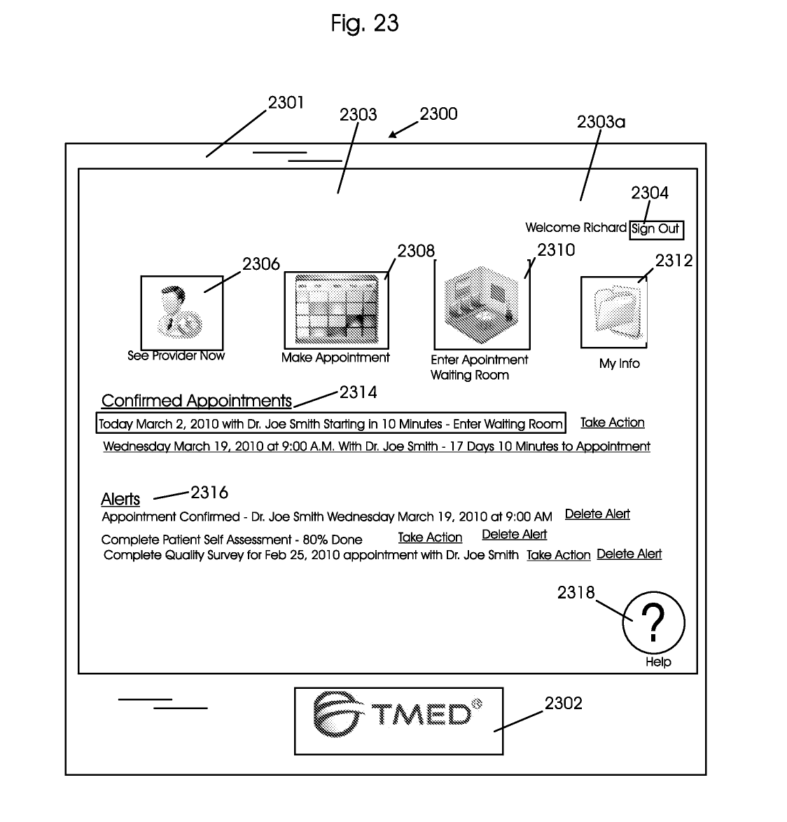

FIG. 2 shows a block diagram of the consumer computer/device 200 for use with the apparatus 100 of FIG. 1. The consumer computer/device 200 may include a computer/device memory 202, a computer/device interactive device 204, a computer/device processor 206, a computer/device display 208, and a computer/device input/output port 210. The computer/device input/output port 210 may be connected to or in communications with the internet 106. The computer/device memory 202, the computer/device interactive device 204, the computer/device display or monitor 208 and the computer/device input/output port 210 may be connected to, or in communications with the computer/device processor 206 by communications links. The computer/device memory 202 may be any kind of computer/device memory. The computer/device interactive device 204 may include a computer/device keyboard, a computer/device mouse, a touch screen, a mobile smart phone, and/or any other computer/device interactive device. The computer/device display 208 may be a computer/device monitor. The patient/consumer computer/device 200 may be multi-purpose device such as a computer, a mobile phone, a video game system or a television with the appropriate hardware and software to support the TMED application. The patient/consumer computer/device 200 may also be a single-purpose device which has been optimized for the delivery of medical care, counseling, and education such as the one pictured in FIG. 23. The optimized computer/device 200 may have a series of integrated light emitting diodes (LED) or similar lighting across the front of the computer/device display 208 where the intensity is controlled by the patient/consumer to enhance the quality of the video capture. The computer/device 200 may have a software/hardware key (for example a public key infrastructure (PKI) token) that is used to identify the device to the TMED server computer/device 102. The software/hardware key may be used for encryption of data and video.

The patient/consumer computer/device 200, the computer interactive device 204, and/or the port 210 may include a video camera, a microphone, wired and wireless communications capabilities to connect to the internet, wired and wireless communication capabilities to connect and collect data from other related devices, such as a glucose meter or a pedometer. The collected data may be added to the patient/consumers electronic medical record (EMR)/personal health record (PHR), which may be stored in EMR/PHR computer/device 104. The microphone and video camera may be used to enable bio-metric security of the device and the TMED computer software application. The video camera may be used for facial recognition or for fingerprint recognition security. The microphone may be used for voice recognition security. A dedicated finger print reader may be connected to the patient/consumer computer/device 200, such as via port 210, for fingerprint recognition security. The patient consumer computer/device 200 may have integrated encryption hardware and/or software to optimize video conference security and performance.

Internet browser computer/device software, such as Internet Explorer (trademarked) is stored in the computer/device memory 202 and is executed and/or used by the computer/device processor 206 to implement and/or execute web pages downloaded to the consumer computer/device 200 (to computer/device processor 206 and memory 202, via computer/device input/output port 210 and the internet 106) from the server computer/device 102 as known in the art.

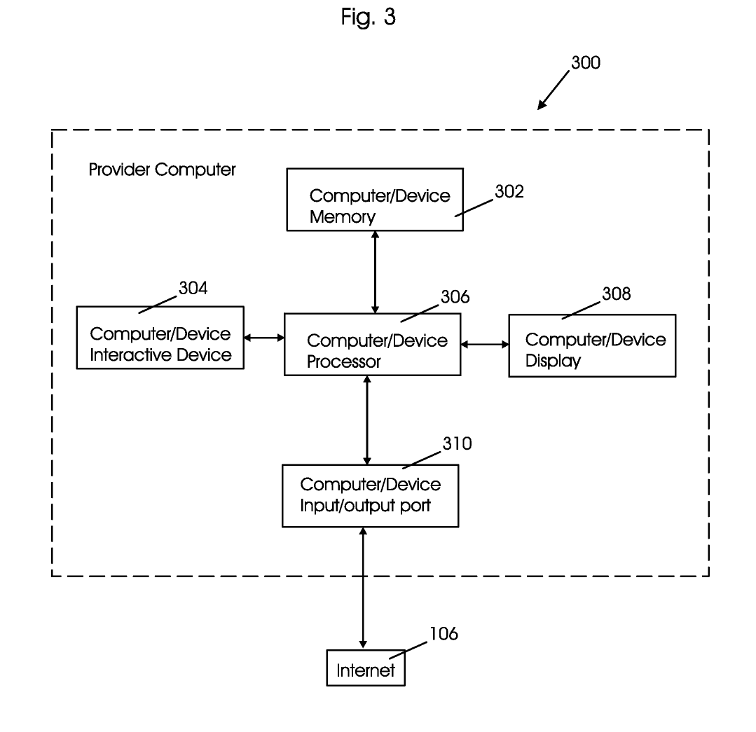

FIG. 3 shows a block diagram of a provider computer/device 300 for use with the apparatus 100 of FIG. 1. The provider computer/device 300 may include a computer/device memory 302, a computer/device interactive device 304, a computer/device processor 306, a computer/device display 308, and a computer/device input/output port 310. The computer/device input/output port 310 may be connected to or in communications with the internet 106. The computer/device memory 302, the computer/device interactive device 304, the computer/device display or monitor 308 and the computer/device input/output port 310 may be connected to, or in communications with the computer/device processor 306 by communications links. The computer/device memory 302 may be any kind of computer/device memory. The computer/device interactive device 304 may include a computer/device keyboard, a computer/device mouse, a touchscreen, and/or any other computer/device interactive device. The computer/device display 308 may be a computer/device monitor. The computer/device 300 may have a software/hardware key (for example a public key infrastructure (PKI) token) that is used to identify the device to the TMED server computer/device 102. The software/hardware key may be used for encryption of data and video.

Internet browser computer/device software, such as Internet Explorer (trademarked) is stored in the computer/device memory 202 and is executed and/or used by the computer/device processor 206 to implement and/or execute web pages downloaded to the consumer computer/device 200 (to computer/device processor 206 and memory 202, via computer/device input/output port 210 and the internet 106) from the server computer/device 102 as known in the art.

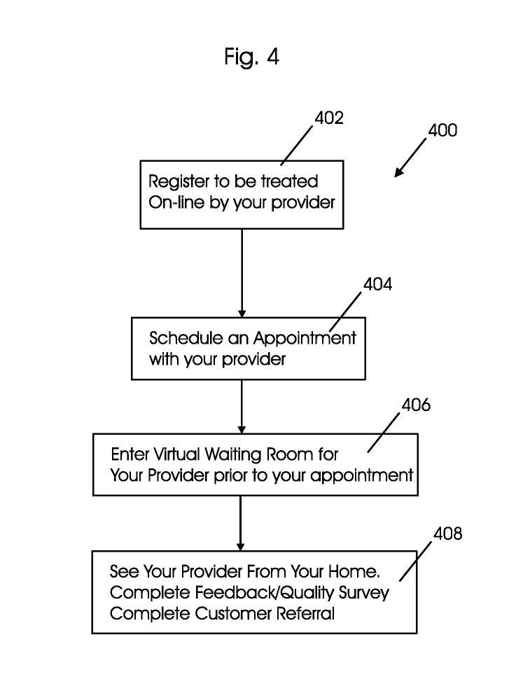

FIG. 4 shows a flowchart 400 of a consumer process or method. The method may include a consumer registering on a web site, which can be called a TMED (registered trademark) web site. The TMED web site may be hosted by the server computer/device 102 shown in FIG. 1. A consumer may access the TMED web site by using the computer/device interactive device 204 of the consumer computer/device 200. The consumer may download a home web page for the TMED web site from the server computer/device 102, through the internet 106, through the computer/device input/output port 210, and through the computer/device processor 206. The computer/device processor 206 of the consumer computer/device 200 may cause the home web page of the TMED web site to be displayed on the computer/device display or monitor 208 of the consumer computer/device 200, in response to entry of the web site home page address by a consumer into the computer/device interactive device 204. The web site home page address would typically be provided from the computer/device interactive device 204 to the computer/device processor 206, which would then request the web site home page for the TMED web site from the server computer/device 102, through the internet 106 and through the computer/device input/output port 210.

The TMED web site home web page or some other web page which is part of the TMED web site may include a form which allows a patient/consumer to enter his or her patient/consumer information. Patient/consumer information may include patient/consumer's name, last, first, and middle initial; patient/consumer's primary care physician; patient/consumer's address, such as street, city, state, and zip, code; patient/consumer's social security number; patient/consumer's gender; patient/consumer's medical and/or dental insurance information including insurance copayment amount, insurance effective date, insurance identification or policy number, insurance group number, an indication of the subscriber for the insurance and relationship to subscriber of insurance, insurance subscriber's date of birth, insurance subscriber's employer, insurance subscriber's social security number; payment information for patient/consumer payment to insurance company, such as patient/consumer credit card number, patient/consumer credit card expiration date, patient/consumer credit card security code, and patient/consumer credit card billing address.

Information stored in an EMR (electronic medical record)/personal health record (PHR) for a particular patient/consumer may include a name of a company that stores the EMR/PHR in the EMR/PHR computer/device 104, such as for example Google (trademarked) and a record identification code for the particular EMR/PHR record for the particular patient/consumer, and to transmit this registration information to the server computer/device 102 at step 402 of FIG. 4. The server computer/device 102 may store the registration form information in its computer/device memory and database.

The TMED web site home web page or some other web page which is part of the TMED web site may include an appointment form for allowing the consumer to schedule an appointment with a provider of medical care, counseling, or education services. A consumer may transmit an appointment form to the server computer/device 102, and the server computer/device 102 may store this appointment form in its computer/device memory, at step 404 of FIG. 4. An individual or provider of medical care, counseling, or education services, using the provider computer/device interactive device 304 may be able to access the appointment form in memory of the server computer/device 102 via the provider computer/device processor 306, the provider computer/device input/output port 310, and the internet 106. The appointment form may specify a time to see a provider of medical care, counseling, or education services. The provider may confirm the appointment and send back an acknowledgement of accepting the appointment to the consumer interface.

At the time of the appointment, the consumer that made the appointment may be able to “enter” a virtual waiting room for the provider at the time of the appointment or just prior to the appointment at step 406 of FIG. 4. The consumer can do this through the consumer computer/device 200 using computer/device interactive device 204 by accessing the TMED web site, via the server computer/device 102, the internet 106, the computer/device input/output port 210 and the computer/device processor 206 and by selecting the menu item to enter the virtual waiting room. After seeing a provider, such as a doctor, or nurse, or a counselor, by communicating via the internet 106 from consumer computer/device 200 to the server computer/device 102, a consumer may complete a feedback/quality survey and referral form or web page, at step 408, which may be automatically downloaded to the consumer computer/device 200 from the server computer/device 102. The completed survey and referral form may be sent from the consumer computer/device 200 to the server computer/device 102. The survey and referral will be stored in a database and be used by the matching engine process or computer/device software run by the server computer/device 102.

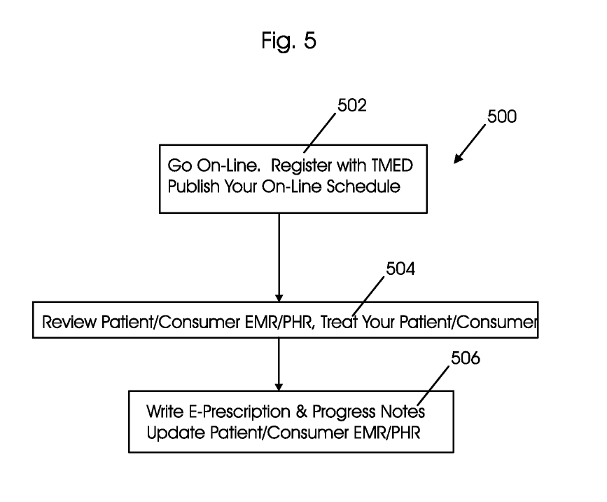

FIG. 5 shows a flowchart 500 of a provider process. At step 502 a provider may go on line, such as by using provider computer/device 300. The provider may register with the TMED web site at step 502 by downloading the TMED web site home web page from the server computer/device 102 to the provider computer/device 300, via the internet 106, the computer/device input/output port 310, and the computer/device processor 306. The TMED web site home web page may include a registration form for a provider of medical care, counseling, or education services to fill out. After the registration form is filled out, using for example the computer/device interactive device 304 of the provider computer/device 300, the registration form can be transmitted to the server computer/device 102, using computer/device processor 306, and via the input/output port 310 and the internet 106. The completed provider registration form may be stored in computer/device memory of the server computer/device 102. The provider submitted registration information may be validated by TMED personnel to confirm provider information.

The TMED web site may also include a schedule form on a web site for entering a provider's schedule. A provider may enter their schedule on the schedule form using computer/device interactive device 304, and may transmit the completed schedule form to the server computer/device 102 (using processor 306 and via port 310 and internet 106). The server computer/device 102 may store the schedule form in its computer/device memory and may also publish the schedule, such as by making the provider's schedule accessible to a consumer, such as a consumer operating consumer computer/device 200.

At step 504 a provider may review their patient/consumer's information such as their EMR/PHR and consult their consumer remotely such as by providing communications from a live person from provider computer/device 300 to consumer computer/device 200 through internet 106. If the internet is unavailable or if there are computer/device problems, consultations may occur over the telephone or through other means.

At step 506 a provider using provider computer/device 300 may enter an electronic prescription and progress notes for a consumer (by using computer/device interactive device 304) and may transmit this information to the consumer computer/device 200 or to the server computer/device 102 for access by a consumer. An EMR (electronic medical record)/personal health record (PHR) of a particular consumer may also be updated with the given information.

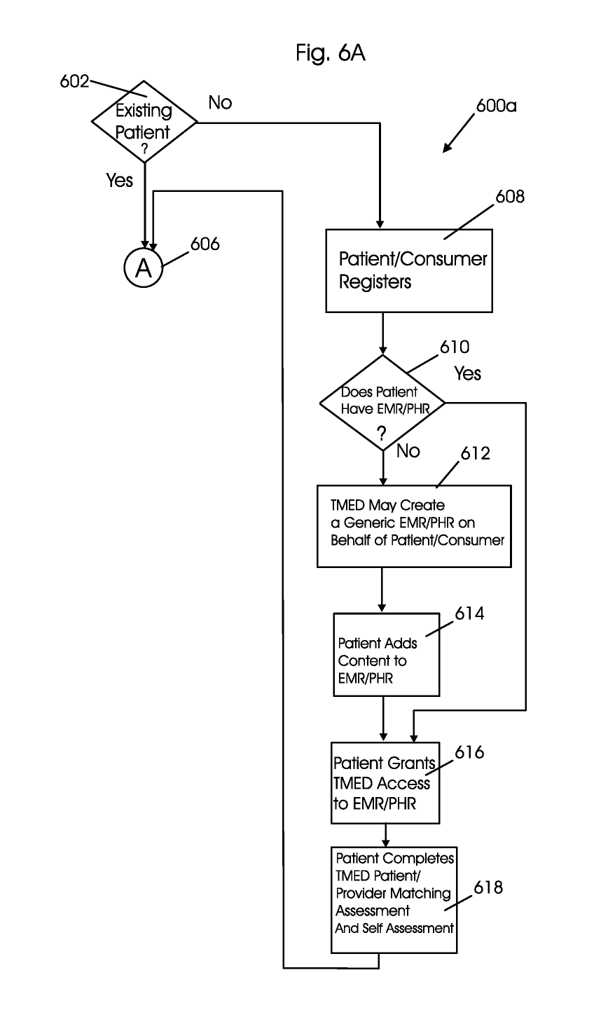

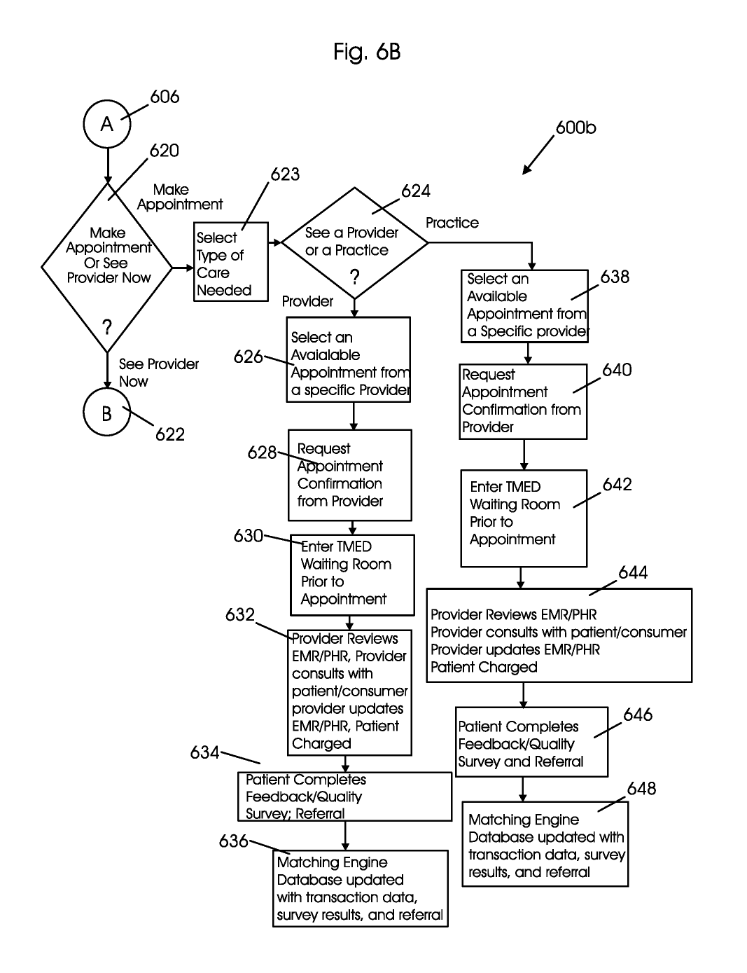

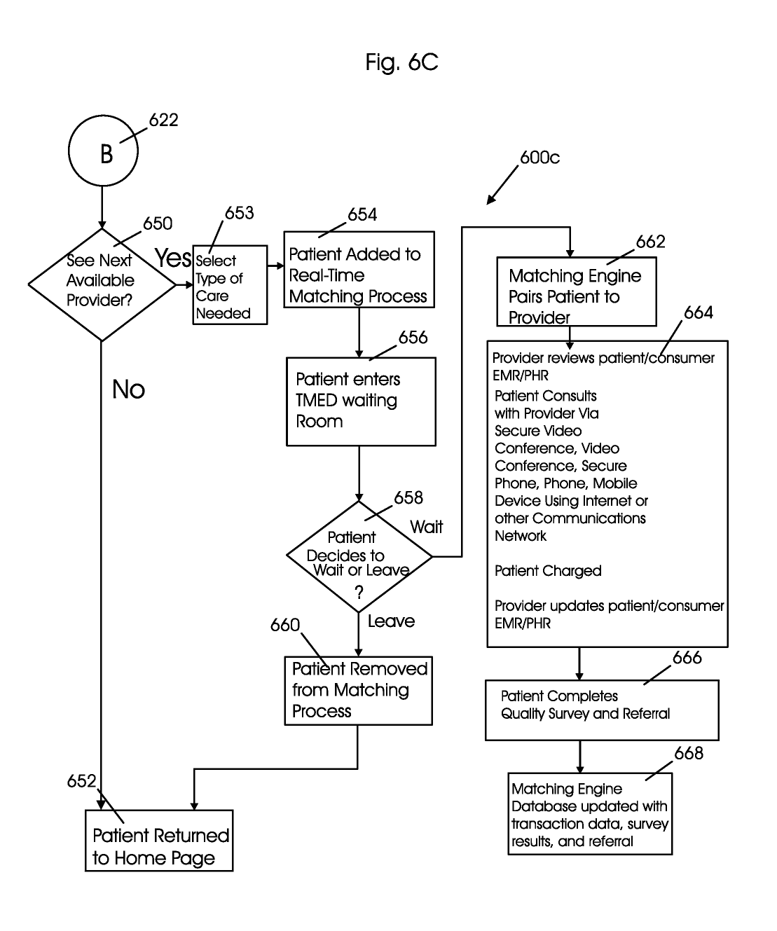

FIGS. 6A-6C show a flowchart, including flow chart portions 600a, 600b, and 600c respectively, of another consumer process. The server computer/device 102 may provide one or more web pages of a web site to the consumer computer/device 200 through the internet 106 in order to execute one or more steps of the process shown by flow chart portions 600a-c. For example a web page provided by the server computer/device 102 to the consumer computer/device 200 may display a field on the computer/device display 208 asking whether the consumer is an existing consumer at step 602. If the consumer is an existing consumer or patient, the process executed by computer/device processor 206 may go to step or node 606 in FIG. 6A.

If the user of consumer computer/device 200 is not an existing consumer, then the consumer registers at step 608 shown in FIG. 6A, using the computer/device interactive device 204 to provide registration information to the server computer/device 102, via the computer/device processor 206, the port 210 and the internet 106. At step 610, a web page provided by the server computer/device 102 to the consumer computer/device 200 may display a field on the computer/device display 208 asking whether the consumer has an electronic medical record (EMR)/personal health record (PHR). If the consumer indicates that he or she does not have an EMR/PHR, that indication is sent to the server computer/device 102. The server computer/device 102 is programmed by a computer/device software program, which can be called TMED, to create an electronic medical record (EMR)/personal health record (PHR) in computer/device memory of the server computer/device 102 or in the EMR (electronic medical record) computer/device 104 on behalf of the consumer at step 612, in response to the indication that the consumer does not have an EMR. The consumer can add content to the EMR at step 614 by using the computer/device interactive device 204 to enter information which is then sent to the server computer/device 102, via processor 206, port 210, and the internet 106. The consumer may grant the TMED computer/device software program or a TMED company access to the consumer's EMR at step 616, by entering appropriate information through a web page provided by server computer/device 102 and through computer/device interactive device 204, which is then sent to server computer/device 102, via processor 206, port 210 and internet 106, and which is then stored in computer/device memory of server computer/device 102. The process for a consumer to grant access, create or, update an electronic medical record (EMR)/personal health record (PHR) is published by EMR providers such as Google (trademarked) and Microsoft (trademarked) and is well known by those in the skilled in the art. The interfaces for the TMED application to request access, create or, update an electronic medical record (EMR)/personal health record (PHR) is published by EMR providers such as Google (trademarked) and Microsoft (trademarked) and is well know by those in skilled in the art.

The consumer may grant the TMED computer/device software program or a TMED company access to the consumer's EMR at step 616, by entering appropriate information through a web page provided by EMR computer/device 104 and through computer/device interactive device 204, which is then sent to server computer/device 102, via processor 206, port 210 and internet 106, and which is then stored in computer/device memory of server computer/device 102. The consumer or patient may choose not to utilize an Electronic Medical Record if the consumer chooses not to share medical history with the provider. The provider will still be able to consult with the consumer, but will not have access to the consumer's electronic medical history. The consumer may complete a TMED consumer/provider matching assessment form using consumer computer/device 200 at step 618 and information concerning this form may be provided to the server computer/device 102, via processor 206, port 210 and the internet 106. If a consumer indicates that he or she does have an electronic medical record at step 610 then the process continues at step 616.

The process continues with step 606 shown in FIG. 6B. Next at step 620, the consumer or user of consumer computer/device 200 is asked whether he or she wants to make an appointment with a provider of medical care, counseling, or education services at step 620 through a web page provided by the server computer/device 102 to the consumer computer/device 200. If the answer is no then the process continues at step 622 or node B. If the answer is yes then the patient/consumer is prompted to select type of care needed at step 623 of FIG. 6B. Next, the consumer is asked whether he or she wants to “see” a provider of medical care, counseling, or education services and/or goods or see a practice concerning medical care, counseling, or education services and/or goods at step 624 through a web page provided by the server computer/device 102 to the consumer computer/device 200. Generally, in one or more embodiments of the present invention, the consumer “sees” a provider in a virtual sense, i.e. typically through a telecommunications device over the internet. “Seeing” a provider may include receiving instructions over the internet, from a provider, even if a human person provider is not visually seen. If the consumer does not want to see a provider from a practice then the process continues with step 626 where a consumer can select an available appointment time from a specific provider by selecting information from a web page displayed on the computer/device display 208 of the consumer computer/device 200, and provided by server computer/device 102 to the consumer computer/device 200. At step 628 the consumer may request appointment confirmation from a provider, by selecting an indication on a web page displayed on computer/device display 208 of the consumer computer/device 200, using computer/device interactive device 204. This request may be sent to the server computer/device 102 where it is stored in computer/device memory of the server computer/device and can be accessed by the provider computer/device 300 or can be sent to the provider computer/device 300. At step 630, a consumer can enter a TMED virtual waiting room prior to the appointment which was previously made. A consumer can do this by logging onto the TMED web site (by using the consumer computer/device 200 to download a web page from the server computer/device 102 to the consumer computer/device 200), and then select a menu item to enter a virtual waiting room may be provided by the server computer/device 102 sending an indication to the consumer computer/device 200 that the consumer needs to wait until the provider will see the consumer. The consumer may request a phone call from the provider prior to or when it is the consumer's turn to see the provider. This would give the consumer the flexibility to wait for a provider without the need to remain in front of the display terminal. At step 632 a patient/consumer can consult with a provider by using patient/consumer computer/device 200 through, for example internet 106, and via provider computer/device 300. The patient/consumer may be charged for the consultation. The consumer may complete a feedback/quality survey and referral using a computer/device interactive device 204 of the patient/consumer computer/device 200 and the survey and referral information may be sent to the server computer/device 102 and stored in computer/device memory of the server computer/device 102. At step 636, the matching engine computer/device software running on the server computer/device 102 can update the matching engine database based on the survey and referral results.

If a consumer wants to “see” in a virtual sense a provider from a practice at step 624, then the consumer next selects an available appointment from a practice at step 638 using consumer or patient/consumer computer/device 200, interactive device 204, and through processor 206 and internet 106 and provided to the server computer/device 102 to be stored in the computer/device memory of the server computer/device 102. Confirmation may be requested from the provider by the consumer computer/device 200 at step 640, using interactive device 204, and through processor 206 and internet 106 and provided to the server computer/device 102 to be stored in the computer/device memory of the server computer/device 102. The consumer may enter the virtual TMED waiting room prior to an appointment at step 642, which again may include logging into a TMED web site page, provided by the server computer/device 102 to the consumer computer/device 200, and having the server computer/device 102 provide information to the consumer computer/device 200 specifying that the consumer needs to wait. The consumer may request a phone call from the provider prior to or when it is the consumer's turn to see the provider. This would give the consumer the flexibility to wait for a provider without the need to remain in front of the display terminal or computer/device display 208. At step 644 a consumer, using consumer computer/device 200 may consult with a provider from a practice, using provider computer/device 300, via the internet 106 and the consumer may be charged after the consultation. At step 646, the consumer may complete a feedback/quality survey and referral form using computer/device interactive device 204 of the consumer computer/device 200 to complete a form supplied in a web page by the server computer/device 102 to the consumer computer/device 200. The complete survey and referral form may be provided back to the server computer/device 102 and stored in computer/device memory of the server computer/device 102. Rules for a matching engine for matching the consumer with a provider, providers, or practice may be stored and/or updated in computer/device memory of the sever computer/device 102 based on the feedback/quality survey and referral results at step 648.

The process continues with step 622, node B, shown in FIG. 6C. Next at step 650 a web page provided to the consumer computer/device 200 by the server computer/device 102, asks the consumer whether he or she wants to see a next available provider. If the consumer responds no, using the computer/device interactive device 204 of the consumer computer/device 200, which response supplied to the server computer/device 102, then the server computer/device 102 is programmed to supply a home page of the TMED web site to the consumer computer/device 200 at step 652. If the consumer responds yes at step 650, then the consumer is prompted at step 653 to select type of care needed. Next the user or patient/consumer is added to the real-time matching process in the computer/device memory of the server computer/device 102 at step 654. The consumer then enters the TMED waiting room a step 656, which means that a web page is supplied to the consumer or patient/consumer computer/device 200, and displayed on the computer/device display 208, from the server computer/device 102, indicating that the consumer is “in” a virtual waiting room waiting for a provider. The consumer may be asked whether they want to wait or leave at step 658 by a request provided by the server computer/device 102 to the consumer computer/device 200, through a web page, and displayed on the computer/device display 208. If the consumer indicates, by entering information into computer/device interactive device 204, that the consumer wants to leave, the information that the consumer wants to leave will be sent to the server computer/device 102, and the server computer/device 102 will remove the consumer and/or the consumer's name and related data from a matching process stored on the computer/device memory of the server computer/device 102 at step 660. The consumer may be thereafter returned to the home page at step 652, i.e. the server computer/device 102 may send a home web page to the consumer computer/device 200 for display on the computer/device display 208, at step 652.

If the consumer decides to wait at step 658, then the server computer/device 102 will execute computer/device software for a matching engine, stored in the server computer/device 102 memory, at step 662 to pair this particular consumer to a provider. This is typically executed when the consumer first joins the waiting room. If the consumer does not want to wait for the provider, he can leave. At step 664, the consumer may consult with a provider through the consumer computer/device 200, the internet 106 and through the provider computer/device 300. The consumer may request a phone call from the provider prior to or when it is the consumer's turn to see the provider. This would give the consumer the flexibility to wait for a provider without the need to remain in front of the display terminal or computer/device display 208. The consumer may consult with the provider via secure video conference, video conference, secure phone, phone, mobile device using the internet or other communications network. The consumer may be charged a certain amount of money for the consultation at step 664. The server computer/device 102 may send a web page to the consumer computer/device 200 including a quality survey and referral which may be filled in at the consumer computer/device 200 and returned and then stored in computer/device memory of the server computer/device 102 at step 666. The matching engine computer/device software of the server computer/device 102 may store and/or update matching engine database based on the quality survey and referral results at step 668.

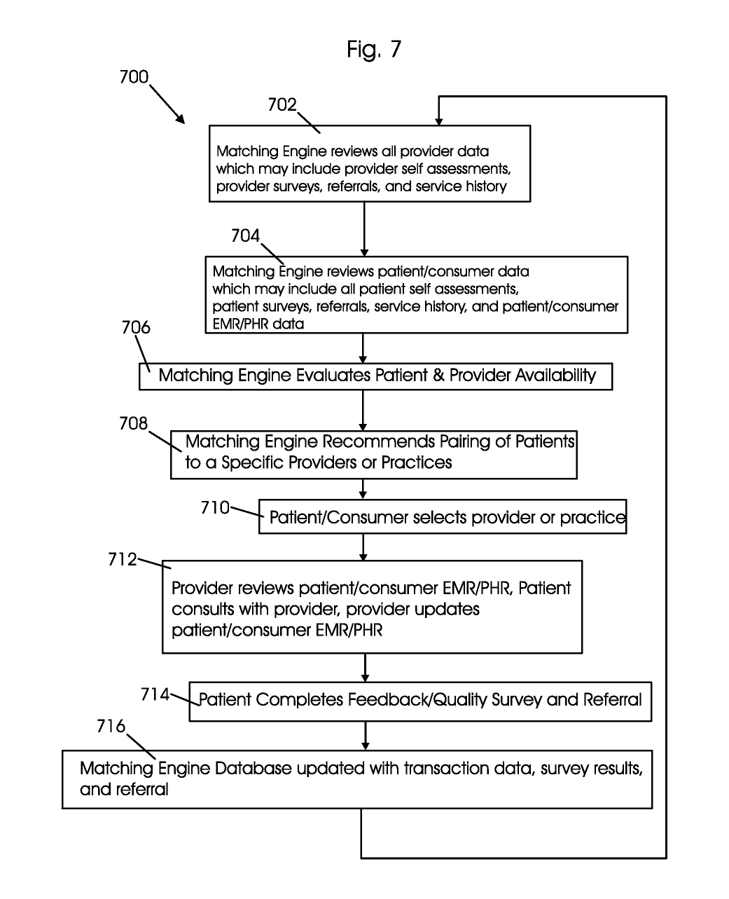

FIG. 7 shows a flowchart 700 of a matching engine process for computer/device software which can be stored in computer/device memory of the server computer/device 102 of FIG. 1. At step 702 provider data including all provider self assessments and provider/consumer surveys and referrals and service histories stored in computer/device memory of the server computer/device 102 is reviewed by the server computer/device 102. At step 704 consumer data from all consumer self assessments and provider/consumer survey and referrals and medical histories stored in computer/device memory of the server computer/device 102 is reviewed by the server computer/device 102. At step 706 the matching engine computer/device software program running on the server computer/device 102, evaluates consumer and provider availability for a specific single consumer and one or more providers. At step 708 the matching engine computer/device software program running on the server computer/device 102 recommends pairing a specific consumer to a specific provider, providers or practice, by providing such recommendations to a consumer computer/device, such as consumer computer/device 200. The consumer may select one of a plurality of providers recommended and provided by the server computer/device 102 to the consumer computer/device 200 through a web page displayed on the computer/device display 208 and provided by the serve computer/device 102, at step 710. The consumer may ignore the recommendations of the matching engine and choose to search through the list of providers or practices that are currently available and choose to enter the virtual waiting room for that specific provider or practice. At step 712, the provider may initiate a consultation, typically by communicating with the consumer computer/device 200 from the provider computer/device 300 through the internet 106, or through some other means. The provider/consumer history for the specific provider and the specific consumer may be updated in a matching engine database stored in computer/device memory of the server computer/device 102. A consumer may complete a feedback quality survey and referral provided by the server computer/device 102 through a web page to the consumer computer/device 200 and also may provide referrals at step 714. The matching engine computer/device software program running on the server computer/device 102 may receive the results of the feedback/quality survey and of referrals and may update a matching engine database stored in computer/device memory of the computer/device server 102 at step 716.

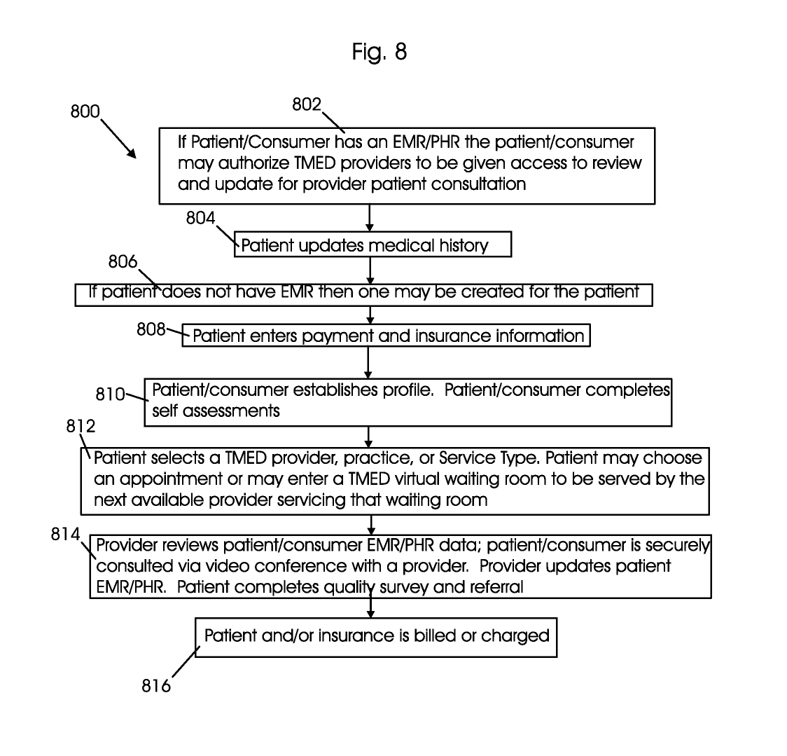

FIG. 8 shows a flowchart 800 of another consumer process. At step 802 if the consumer has an electronic medical record (EMR)/personal health record (PHR) stored in computer/device memory of the server computer/device 102, then the consumer may authorize TMED providers (i.e. providers of medical care, counseling, or education services and/or goods which use the matching engine computer/device software of one embodiment of the present invention stored on computer/device memory of the server computer/device 102 to be given access to review and update during provider/consumer consultation. The consumer may give access to the EMR by signing into an EMR account provided by an EMR company which runs EMR computer/device 104, which may be for example Microsoft (trademarked) HealthVault (trademarked). The EMR account may be an account to which the server computer/device 102 (as directed by the TMED computer/device software) will request to access specific types of health data in patient's electronic medical data record. The consumer may make a request for electronic medical records by entering information into a web page on the computer/device display 208 of the consumer computer/device 200, the web page provided by the server computer/device 102. This access indication can be sent back to the server computer/device 102 and stored in computer/device memory of the server computer/device 102. The consumer may update his or her medical history at step 804 by using computer/device interactive device 204 of the consumer computer/device 200 to provide information to the server computer/device 102, through processor 206, port 210, and the internet 106. If the consumer does not have an EMR stored in computer/device memory of the sever computer/device 102, then an EMR may be created by computer/device software of the server computer/device 102 at step 806. The consumer may enter insurance and payment information into a web page rendered on the computer/device display 208 of the consumer computer/device 200, and provided by the server computer/device 102. The insurance and payment information may be returned to the server computer/device 102 and stored in its computer/device memory. At step 810, the consumer may establish a profile for himself or herself and may select services and providers relevant to the consumer by entering information using computer/device interactive device 204 of the consumer computer/device 200 into a web page or form provided by the server computer/device 102 and returned to the server computer/device 102 and stored in its computer/device memory after the form has been filled in. At step 812, the consumer, using consumer computer/device 200, may select a TMED provider (i.e. a provider which subscribes to the matching service and is registered on the server computer/device 102) practice, or service type through a web page provided by the serve computer/device 102, and this information may also be provided to the server computer/device 102. At step 812, the consumer, using consumer computer/device 200, may also choose an appointment or may enter a TMED virtual waiting room to be served by the next available provider servicing that virtual waiting room. At step 814, the consumer, such as via consumer computer/device 200, may be securely consulted via video conference with a provider, such as via provider computer/device 300, servicing the virtual waiting room. The consumer and/or insurance may be billed or charged at step 816 through electronically or manually charged to the consumer's credit card or electronically or manually billed to a consumer's insurance provider if the consumer is covered for the consultation and has provided the necessary insurance information.

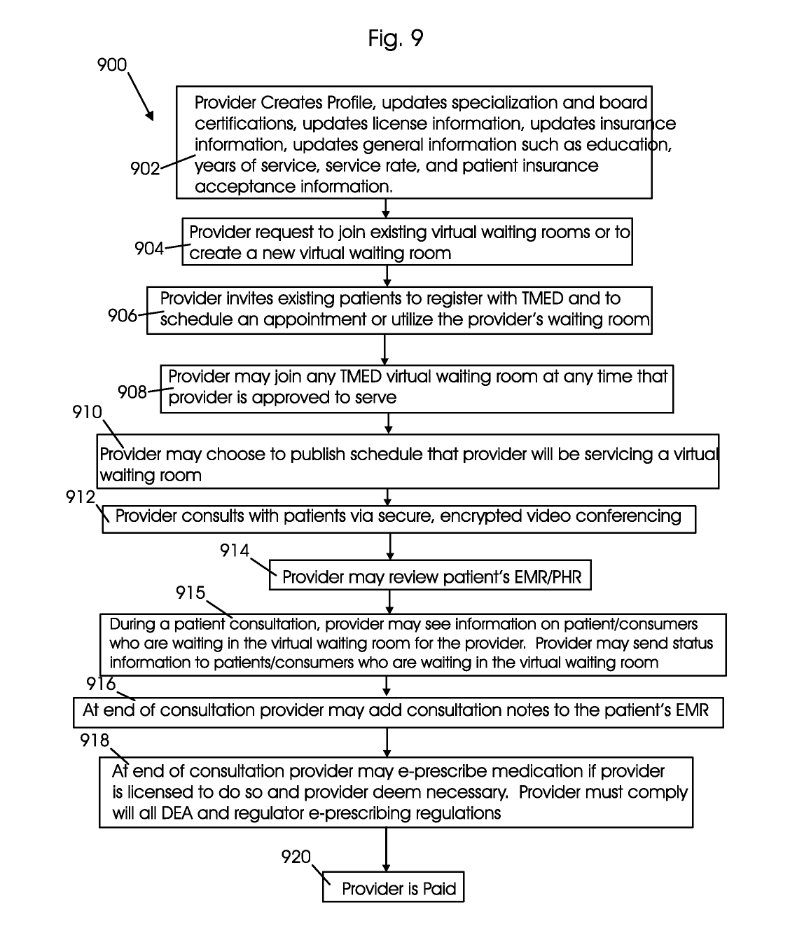

FIG. 9 shows a flowchart 900 of another provider process. At step 902 a provider or person from a provider company or agency, using provider computer/device 300, may create a profile for itself, such as name and other information. The profile may be created using a web page downloaded from the server computer/device 102, and displayed on the computer/device display 308 of the provider computer/device 300. The profile may include board certifications, identification of medical specialization and states in the United States that he or she is licensed to practice in. The profile may include or may be updated to include general information such as education, years of service, medical specialty, and/or other information. The profile may include provider's service rates and may include information on the insurance that the provider will accept. The profile information may be stored in computer/device memory and/or a database of the server computer/device 102

At step 904 the provider may request, by using provider computer/device 300, to join existing virtual waiting rooms, or to create a new virtual waiting room, by supplying a request from provider computer/device 300 to the server computer/device 102, to be stored in computer/device memory of the server computer/device 102. At step 906, provider may invite, by using provider computer/device 300, existing consumers of the provider to register with TMED (i.e. register on the server computer/device 102 for the matching engine process) and to schedule an appointment or utilize the provider's waiting room by for example sending email invitations from provider computer/device 300 to consumer computer/device 200 or other consumer computer/devices, which are consumers of the provider. Once the provider has joined the TMED service, the provider may join any TMED virtual waiting room that the provider is approved by the TMED computer/device software running on the server computer/device 102 to service, through the use of provider computer/device 300 or at any time that provider is approved to service by the server computer/device 102 at step 908. At step 910 the provider may choose to publish a schedule that a provider will be using to service a virtual waiting room. The provider may use the provider computer/device 300 to enter information that may be sent to the server computer/device 102 and stored in computer/device memory of the server computer/device 102 for a schedule for a virtual waiting room. The schedule may be made available via one or more web pages of the TMED web site through the server computer/device 102 to one or more requesting consumer computer/devices, such as consumer computer/device 200. A provider by use of provider computer/device 300 may consult with a consumer, such as by use of consumer computer/device 200 over the internet 106, via secure encrypted video conferencing or via standard video conferencing which is un-encrypted, at step 912. At step 914, a provider may review a consumer's EMR (electronic medical record), which may be provided from computer/device memory of the server computer/device 102 or the computer/device memory of EMR computer/device 104 to the provider computer/device 300 over the internet 106, and may be displayed by the computer/device display 308 of the provider computer/device 300 for review by a human being of a provider company. At step 916, consultation notes may be added by a provider to a consumer's EMR, by a provider by using provider computer/device 300 to input consultation notes via computer/device interactive device 304 which may be sent to the EMR computer/device 104 via processor 306, port 310 and internet 106, and stored with or in a consumer's EMR in computer/device memory of the EMR computer/device 104. At step 918, the provider may e-prescribe medication if necessary at the end of a consultation by inputting e-prescription information via computer/device interactive device 304 which may be sent to server 102 via processor 306, port 310 and internet 106, and stored in computer/device memory of the server 102. The e-prescription may be accessed by a consumer computer/device 200 from a web page provided by the server computer/device 102. The server computer/device 102 may be programmed to make sure that the provider is licensed to prescribe medication and that provider has complied with all DEA (Drug Enforcement Agency) and regulatory e-prescribing regulations. At step 920 the provider may be paid through electronic funds transfer to the providers account. The server computer/device 102 may electronically transmit the e-prescription to a consumer's pharmacy or to an e-prescription service provider that may process the e-prescription.

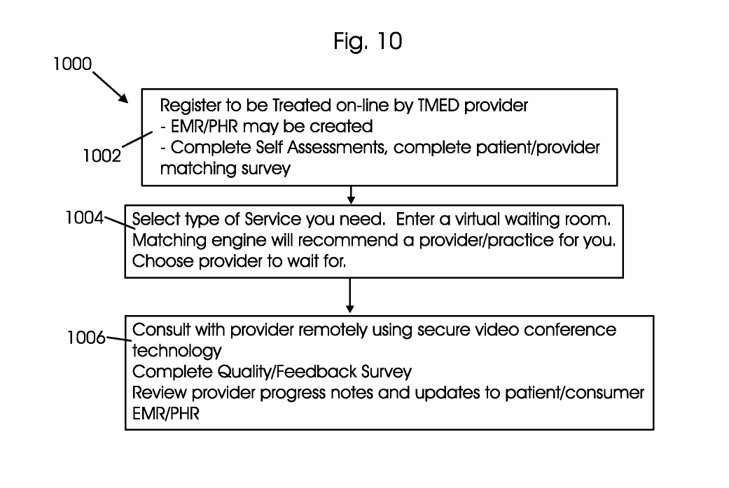

FIG. 10 shows a flowchart 1000 of another consumer process. At step 1002, a consumer may register to be consulted on-line by a TMED provider. As part of the registration process the consumer may create an electronic medical record (EMR)/personal health record (PHR) through the consumer computer/device 200, using computer/device interactive device 204 to create an EMR which is stored in computer/device memory of the EMR computer/device 104 and which can be accessed by a request by the server computer/device 102 and an appropriate authorization of the patient/consumer computer/device 200 by first causing the server computer/device 102 to request and gain authorization to an EMR, and then downloading one or more web pages of a TMED web site with the EMR. The consumer may also complete self assessments, and complete consumer/provider matching survey by providing information via a web page provided by the server computer/device 102 to the consumer computer/device 200. A consumer can select, using the computer/device interactive device 204 of the consumer computer/device 200, the type of service needed at step 1004 and enter a virtual waiting room, whose characteristics may be displayed on the computer/device display 208. A matching engine computer/device software program running on the computer/device server 102 may be used to recommend a plurality of providers/practices for a consumer, by supplying a list of providers from the computer/device server 102 to the consumer computer/device 200. The consumer may then use consumer computer/device 200 to choose or select a provider to wait for. The selection of the provider may be provided to the server computer/device 102.

At step 1006, the consumer may consult with a provider remotely using secure video conference technology through consumer computer/device 200, the server computer/device 102, and the provider computer/device 300. A consumer may complete a quality/feedback survey and referral by use of consumer computer/device 200 and this information can be provided to the server computer/device 102.

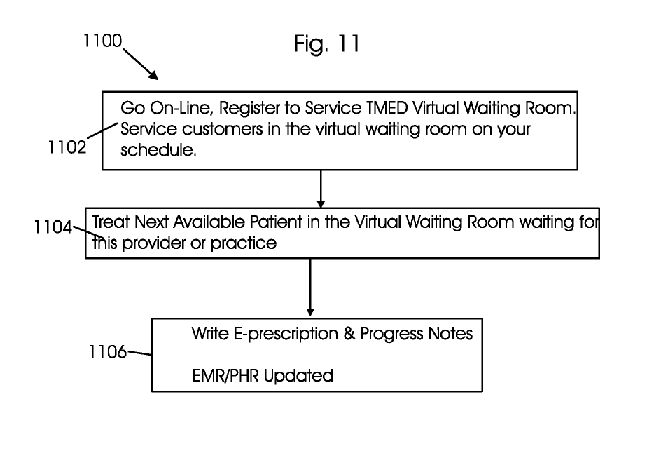

FIG. 11 shows a flowchart of another provider process. At step 1102, a provider can go on line by using the consumer computer/device 200 to download a web page from the server computer/device 102 and can use this web page to enter information, via the computer/device interactive device 204 to register to service a particular virtual waiting room. The provider can service consumers in the virtual waiting room on a schedule entered by the provider into the provider computer/device 300 and sent to and stored in the computer/device memory of the server computer/device 102. At step 1104, the provider can consult the next available consumer in the virtual waiting room, such as by providing information for consultation via computer/device interactive device 304 of the provider computer/device 300, which is sent to the server computer/device 102 thereafter sent to the consumer computer/device 200. The provider may review a patient/consumer's data and electronic medical record (EMR). At step 1106, the provider may write e-prescriptions and progress notes, using the computer/device interactive device 304 of the provider computer/device 300 and which may be sent to the consumer computer/device 200 and/or the server computer/device 102. The EMR (electronic medical record) of a consumer which may be stored in computer/device memory of the server computer/device 102, or in EMR computer/device 104 may be updated by the e-prescription and/or progress notes and/or other information.

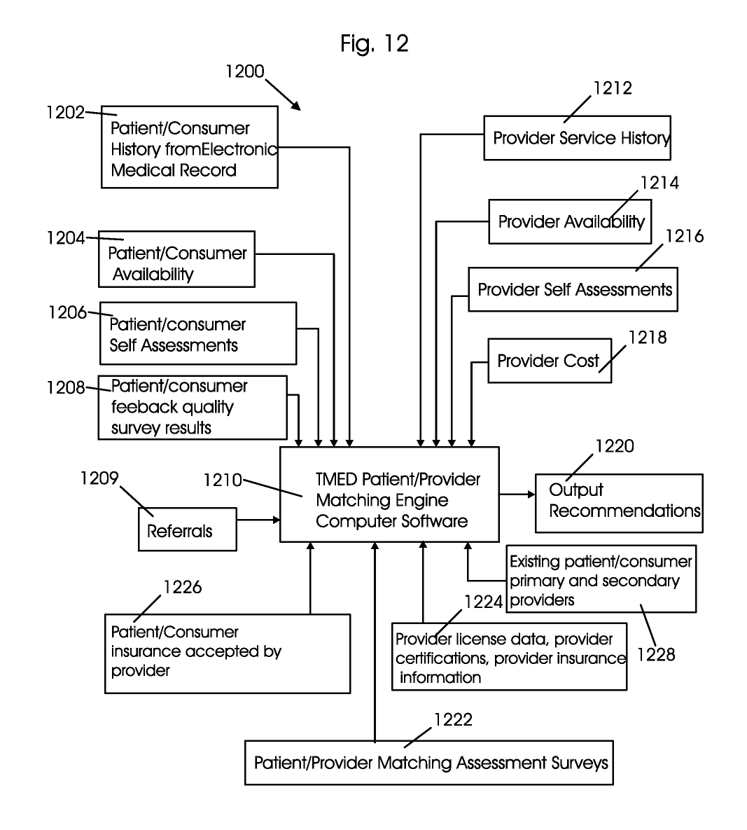

FIG. 12 shows a block diagram 1200 of information provided to a matching engine computer/device software program 1210 running on and stored in computer/device memory of the server computer/device 102 of FIG. 1. FIG. 12 also shows output recommendations 1220 which are provided based on various inputs to the matching engine 1210.

In accordance with one or more embodiments of the present invention, inputs are provided to the matching engine 1210 from a consumer, such as entered by a consumer through computer/device interactive device 204 via a consumer computer/device 200 and provided to a server 102. The consumer inputs may include input 1202—consumer history from electronic medical record (EMR), input 1204—consumer availability, input 1206—consumer self assessments, and input 1208—consumer feedback quality survey and referral results. In addition, inputs are provided to the matching engine 1210 from a provider, such as entered by a person working for a provider through computer/device interactive device 304 via a provider computer/device 300 and provided to server computer/device 102. The provider inputs may include input 1212—provider service history, input 1214—provider availability, input 1216—provider self assessments, input 1209—regarding referrals, input 1218—provider cost, input 1224—provider license data and provider board certification data, input 1226—provider insurance acceptance data, and input 1228—existing patient/consumer primary and secondary providers. In addition a combination consumer/provider input 1222 of consumer/provider matching assessment surveys may be provided to the matching engine 1210. The matching engine, running on the server computer/device 102, may produce output recommendations 1220. The output recommendations 1220 may include recommendations of providers or practices that are tailored to the unique needs of a consumer based on one, many, or all of the inputs 1202, 1204, 1206, 1208, 1212, 1214, 1216, and 1218. The output recommendations 1220 may include a list of providers or practices for a consumer to choose from. A consumer may choose from the list of providers provided in the output recommendations 1220 or may choose to ignore the recommendations and search from a list of all available providers or practices that are registered with the server computer/device 102.

The matching engine computer/device software 1210 stored in computer/device memory of and running on the server computer/device 102 may provide a consumer, such as one using consumer computer/device 200, with information on all providers registered with the TMED web site of the server computer/device 102. Information concerning the education, years of service, specialty, average consumer rating and cost may be provided by the server computer/device 102 to the consumer computer/device 200 via the internet 106. The information may be displayed on the computer/device display 208 through the use of a web page or pages downloaded from the server computer/device 102.

The server computer/device 102 may provide a web page virtual waiting room for a provider in response to a request from a consumer computer/device 200. In one or more embodiments, a consumer need not make an appointment before accessing the web page virtual waiting room. In a no appointment necessary embodiment, consumers may be serviced by a provider on a first come first serve basis. In a particular virtual waiting room, a web page may be displayed on a consumer computer/device display 208 (as provided from the server computer/device 102) which may show the number of consumers waiting, the names of all of the providers servicing the waiting room (including summary information on every provider), and the particular consumer's position in the waiting room. This embodiment gives consumers the flexibility to wait for health care services without the need for an appointment. Consumers can choose to exit the virtual waiting room at any time (such as by logging off the web site or web page or shutting off the consumer computer/device 200). When one consumer leaves the virtual waiting room everyone else in line (in the queue) advances. If a consumer is next to be serviced but does not respond, such as by activating the computer/device interactive device 204 in some way, to a request, such as a visual alert on the computer/device display 208 of the consumer computer/device 200, then the next consumer may be serviced. Failure to respond to a second request may result in putting the consumer to the back of the line (queue). Failure to respond a third time may result in removing the consumer from the line (queue). In a least one embodiment, a consumer is only charged when a consultation begins.

Providers may provide services through matching engine 1210 and computer/device server 102 as part of a practice or independent of the practice. A provider may leave a virtual waiting room at any time after completing a consumer consultation, such as using the provider computer/device 300 to log off a web site provided by the server computer/device 102 of or shutting down the provider computer/device 300. In at least one embodiment, a provider, using provider computer/device 300, must be authorized by the TMED software running on the computer/device server 102 in order to service a virtual waiting room. In one embodiment, once authorized, a provider may service consumers in a particular virtual waiting room, at the provider's convenience.

In one embodiment, consumers with an appointment can log in to the TMED web site, using the consumer computer/device 200, to see the status of their virtual waiting room appointment and provider. If the provider is behind schedule, the consumer may be updated by data sent from the computer/device server 102 to the consumer computer/device 200 and displayed on the computer/device display 208, and the consumer can choose to wait for the provider. In one embodiment, if the consumer does not “show” for an appointment, i.e. is not available on line in the virtual waiting room and does not respond when requested to, then the consumer may be charged. Any fees for not showing for an appointment may be communicated in advance of a consumer making an appointment. The provider may be charged a fee for missing an appointment. Provider's rates may be displayed on the computer/device display 208 on a web page downloaded from the computer/device server 102 to allow the consumer to decide which provider to choose based at least in part on cost. The server computer/device 102 may provide a web page to the consumer computer/device 200 which includes ratings concerning providers. The consumer, by use of consumer computer/device 200 may decide which provider to choose based on ratings and other factors displayed.

Consultations between the consumer, via consumer computer/device 200, and the provider, via provider computer/device 300, may be provided by encrypted video over the internet 106 to secure the privacy of the consultations. The consumer computer/device 200 and the provider computer/device 300 may communicate via a personal area network (PAN), wireless local area network (WIFI) (trademarked), Ethernet, wireless, or other technologies to connect the consumer computer/device 200 or the provider computer/device 300 with the internet 106. Each of the consumer computer/device 200 and/or the provider computer/device 300 may include mobile smart phones or tablet computer/device devices including devices supporting video conferencing.

Providers registered with the TMED solution system or computer/device software 1210 on the server computer/device 102, in at least one embodiment, are able to review a consumer's EMR, assuming the consumer is also registered on TMED. Providers registered with the TMED solution system or computer/device software 1210 on the server computer/device 102 are able to add notes from their consultation via, for example, provider computer/device 300, into the consumer's EMR stored in computer/device memory of the EMR computer/device 104.

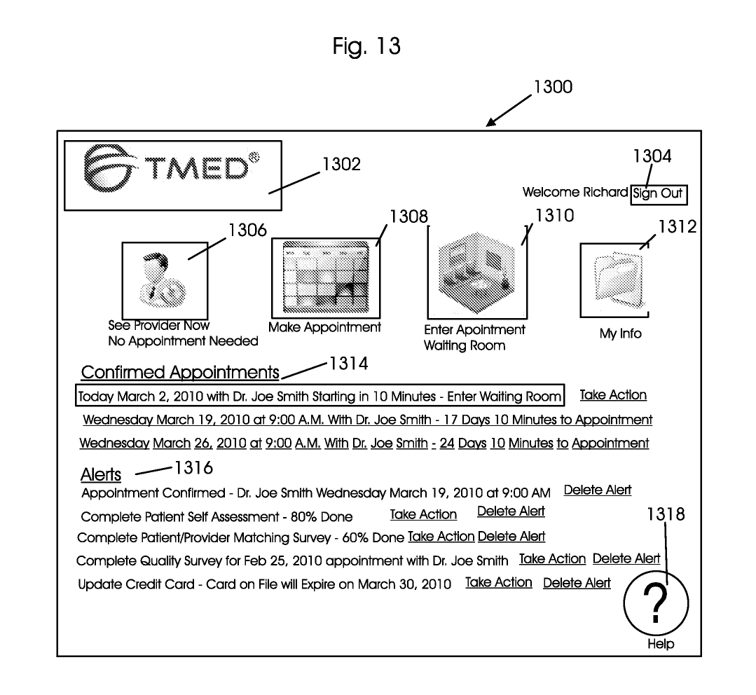

FIG. 13 shows an image 1300 for display on the computer/device display 208 of the patient/consumer computer/device 200 by the computer/device processor 206 of FIG. 2 in accordance with an embodiment of the present invention. The image 1300 may be a rendering of a home web site page which is downloaded from the server computer/device 102 to the patient/consumer computer/device 200 for a web site called the TMED (trademarked) web site. The image 1300 may appear on the computer/device display 208 after a patient/consumer inputs a web site address for the TMED web site home page into the computer/device interactive device 204, which is then sent via processor 206, port 210 and internet 106 to access the TMED web site home page. The web site home page may include an HTML (hypertext markup language) file which is rendered into the image 1300 by computer/device browser software stored in the computer/device memory 202 and running on the computer/device processor 106.

The image 1300 shown in FIG. 13 includes a section 1302 showing the trademark TMED and symbol. The image 1300 further includes section, fields, portions, or buttons 1304, 1306, 1308, 1310, 1312, 1314, 1316, and 1318. Section 1304 includes text “Welcome Richard” which indicates that the patient/consumer's name is “Richard” and welcomes the patient/consumer to the TMED (trademarked) web site. Section 1304 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1300 is taken off of the computer/device display 208 and the patient/consumer no longer is using the TMED (trademarked) web site.

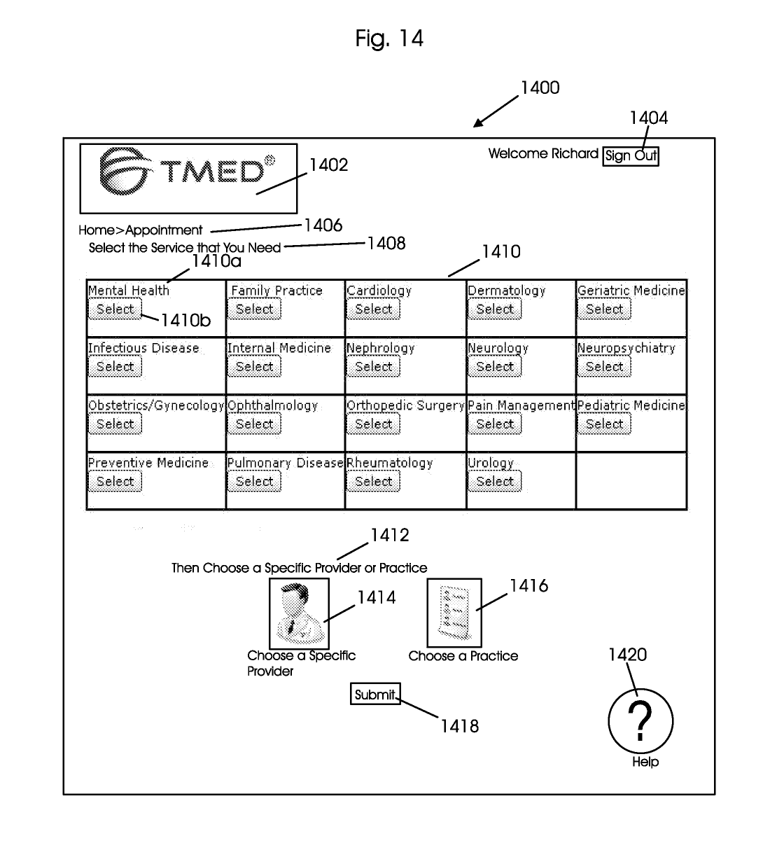

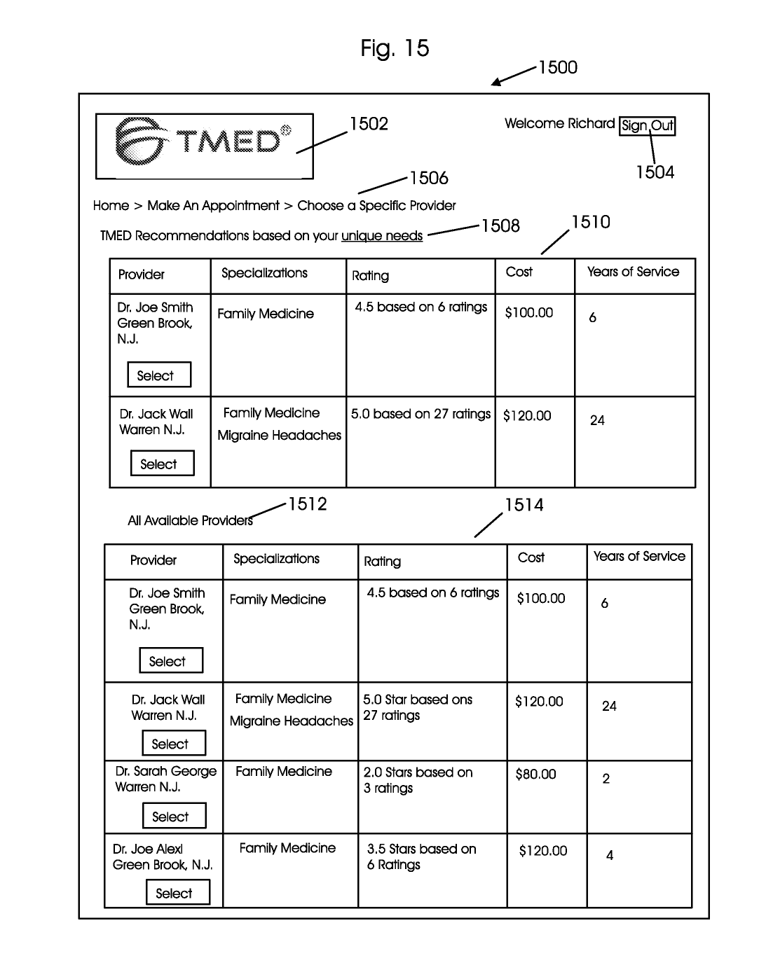

Section 1306 includes an image or icon of a doctor and text underneath it which states “See Provider Now No Appointment Needed”. The image or icon in section 1306 or the text underneath it can be clicked on using a computer/device mouse of computer/device interactive device 204 to cause the computer/device processor 206, by executing internet browser computer/device software, to next request a web page from the server computer/device 102, which is rendered and displayed to start the process of a virtual visit by a patient/consumer with a provider and allows the patient/consumer to select the type of service needed. This web page is a rendering of FIG. 14 for the “See Provider Now No Appointment Needed” model. Then the consumer selects a provider and a rendering of FIG. 15 is displayed for providers of the “See Provider Now No Appointment Needed” model.

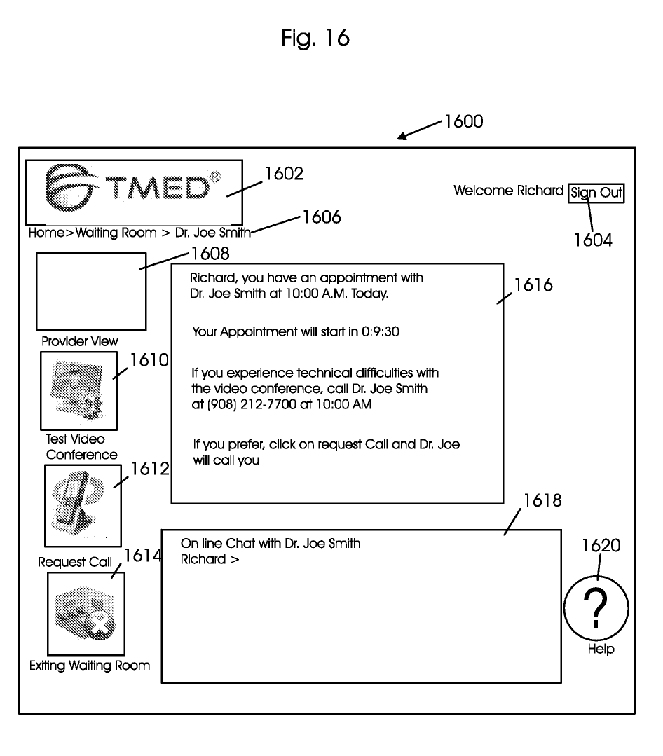

Section 1308 includes an image or icon of a calendar and text underneath it which states “Make Appointment”. The image or icon in section 1308 or the text underneath it can be clicked on using a computer/device mouse of computer/device interactive device 204 to cause the computer/device processor 206, by executing internet browser computer/device software, to next request a web page from the server computer/device 102 which is displayed in FIG. 14 to start the process of a patient/consumer making an appointment with a provider. Section 1310 includes an image or icon of a waiting room and text underneath it which states “Enter Appointment Waiting Room”. The image or icon in section 1310 or the text underneath it can be clicked on using a computer/device mouse of computer/device interactive device 204 to cause the computer/device processor 206, by executing internet browser computer/device software, to next request a web page from the server computer/device 102 which is displayed in FIG. 16 to start the process of a patient/consumer entering a virtual waiting room. Section 1312 includes an image or icon of a file and text underneath it which states “My Info”. The image or icon in section 1312 or the text underneath it can be clicked on using a computer/device mouse of computer/device interactive device 204 to cause the computer/device processor 206, by executing internet browser computer/device software, to next request a web page, not shown, to start the process of displaying a patient/consumer's information on the computer/device display 208.

The section 1314 shows “Confirmed Appointments” for the particular patient/consumer, which in this case is “Richard”. In this example, the patient/consumer has three confirmed appointments, the first for Mar. 2, 2010, the second for Mar. 19, 2010, and the third for Mar. 26, 2010, all with Dr. Joe Smith. The appointment which is earliest in time, i.e. in this case the Mar. 2, 2010 appointment, may be highlighted by the computer/device processor 206 on the computer/device display 208, such as by being surrounded by a box as shown. The information for each appointment in section 1314, may include the date and time of the appointment, the appointment of time until the appointment begins, and the provider that the appointment is with. A text link denominated as “Take Action” in section 1314, when clicked using a computer/device mouse or otherwise selected using a computer/device interactive device 204 of the patient/consumer computer/device 200 may cause the computer/device processor 206 to next request a web page from the server computer/device 102 for entering a virtual web page.

The section 1316 shows “Alerts” for the particular patient/consumer (in this case “Richard”). “Alerts” or information shown under alerts and displayed by the computer/device processor 206 on the computer/device display 208, may include confirmation of an appointment, an indication of whether and how much of a patient/consumer self assessment has been done, an indication of whether and how much of a patient/provider matching survey has been done, an indication that a quality survey needs to be done before a particular appointment with a particular provider, and a notification of expiration of a credit card used to pay a provider. Each notation or alert may have a “Delete Alert” button or text link adjacent to it. A patient/consumer can click on the appropriate “Delete Alert” link using, for example, a computer/device mouse of the computer/device interactive device 204, which will cause the computer/device processor 206 to delete the notation or “Alert” directly to the left of the particular “Delete Alert” button clicked on, so that it will not appear in the next version of the home page of the TMED web site (i.e. the next or modified version of image 1300). Some of the notations or alerts have a “Take Action” text link next to the them which allows a patient/consumer to address the problem indentified by the alert. For example, for the “Complete Patient Self Assessment—80% done” indication, clicking the “Take Action” link to the right of that indication, causes the computer/device processor 206 to request a web page from the server computer/device 102 relating to completing a patient/consumer self assessment, referred to in FIG. 6A.

Section 1318 may have a help button which can be clicked on using a computer/device mouse, or otherwise selected by the computer/device interactive device 204 to cause the computer/device processor 206 to request a help web page from the server computer/device 102 which would then be displayed on the computer/device display 208.

FIG. 14 shows an image 1400 for display on the computer/device display 208 of the patient/consumer computer/device 200 by the computer/device processor 206 of FIG. 2 in accordance with an embodiment of the present invention. The image 1400 may be a rendering of a secondary web site page which is downloaded from the server computer/device 102 to the patient/consumer computer/device 200 relating to a web site called the TMED (trademarked) web site. The image 1400 may be displayed by the computer/device processor 206 on the computer/device display 208 after a patient/consumer selects, using the computer/device interactive device 204 of the patient/consumer computer/device 200 the section or link 1308 (“Make Appointment”) in the image 1300 of FIG. 13. The image 1400 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1400 shown in FIG. 14, includes a section 1402 showing the trademark TMED and symbol. The image 1400 further includes section, fields, portions, or buttons 1404, 1406, 1408, 1410, 1412, 1414, 1416, 1418, and 1420. Section 1404 includes text “Welcome Richard” which indicates that the patient/consumer's name is “Richard” and welcomes the patient/consumer to the TMED (trademarked) web site. Section 1404 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1400 is taken off of the computer/device display 208 and the patient/consumer no longer is using the TMED (trademarked) web site.

Section 1406 includes text which indicates that the image 1400 relates to an appointment web page which came from, or was entered through the home web page for the TMED (trademarked) web site. Section 1408 includes text to indicate that a patient/consumer should select the service that he or she desires. Section 1410 is a grid of a plurality of rows and columns showing a service or medical specialty and a “Select” button in each grid unit. For example, in the first row and first column unit, a “Mental Health” specialty, service, or topic 1410a is shown and a “Select” button 1410b is shown for selecting the “Mental Health” specialty, service, or topic.

Section 1412 includes text indicating that the patient/provider should choose a specific provider or practice. Section 1414 includes an image or icon of a doctor and text stating “Choose a Specific Provider”. The image or icon or the text in section 1414 can be clicked on or otherwise selected using computer/device interactive device 204 of the patient/consumer computer/device 200 to choose a specific provider, which will cause the computer/device processor 206 to request a web page, which is a rendering of FIG. 14 where the icon “Choose a Specific Provider” has been enlarged and typically may be be color coded to indicate that it has been selected. Section 1416 includes an image or icon for a practice and text stating “Choose a Practice”. The image or icon or the text in section 1416 can be clicked on or otherwise selected using computer/device interactive device 204 of the patient/consumer computer/device 200 to choose a practice, which will cause the computer/device processor 206 to request a web page, rendering of FIG. 14 where the icon “Choose a Practice” has been enlarged and typically may be color coded to indicate that it has been selected.

Section 1418 includes a submit button which can be clicked on or otherwise selected using the computer/device interactive device 204 to generate the next web page in the process shown in FIG. 15 when the option “Choose a Specific Provider” is selected. When “Choose a Practice” option is selected a rendering of FIG. 15 is displayed listing Practices instead of Providers.

Section 1420 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

FIG. 15 shows an image 1500 for display on the computer/device display 208 of the patient/consumer computer/device 200 by the computer/device processor 206 of FIG. 2 in accordance with an embodiment of the present invention. The image 1500 may be a rendering of a secondary web site page which is downloaded from the server computer/device 102 to the patient/consumer computer/device 200 relating to a web site called the TMED (trademarked) web site. The image 1500 may be displayed by the computer/device processor 206 on the computer/device display 208 after a patient/consumer selects, using the computer/device interactive device 204 of the patient/consumer computer/device 200 the section or link 1314 (“Choose a Specific Provider”) in the image 1400 of FIG. 14. The image 1500 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1500 shown in FIG. 15, includes a section 1502 showing the trademark TMED and symbol. The image 1500 further includes section, fields, portions, or buttons 1504, 1506, 1508, 1510, 1512, and 1514. Section 1504 includes text “Welcome Richard” which indicates that the patient/consumer's name is “Richard” and welcomes the patient/consumer to the TMED (trademarked) web site. Section 1504 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1500 is taken off of the computer/device display 208 and the patient/consumer no longer is using the TMED (trademarked) web site.

Section 1506 includes text which indicates that the image 1500 relates to a “Choose a Specific Provider” web page which came from, or was entered through the “Make An Appointment” Web Page, related to image 1400 in FIG. 14, which came from the home web page related to image 1300 for the TMED (trademarked) web site. Section 1508 includes text stating “TMED Recommendations based on your unique needs” which refers to a table or chart 1510 of recommended providers. The recommended providers in the chart of 1510 are determined by the server computer/device 102 running computer/device software related to the TMED web site. The computer/device software related to the TMED web site on server computer/device 102 uses information about the patient/consumer and providers, and matches and/or recommends a set of providers in chart 1510 which is a subset of all of the providers that are registered or participating in the TMED web site process.

In the example of FIG. 15, the chart 1510 includes information about two recommended providers. The chart 1510 has a title row stating “Provider”, “Specializations”, “Rating”, “Cost”, and “Years of Service.” The chart or table 1510 also have two rows, each of which has information about a specific provider. The first provider row refers to a health service provider named “Dr. Joe Smith”. The first column of the first provider row shows his name “Dr. Joe Smith”, the town or city and state in which his office his located, and a “Select” button which can be clicked on or otherwise selected using computer/device interactive device 204 to allow the patient/consumer to select Dr. Joe Smith. The second column of the first provider row shows Dr. Joe Smith's specializations as “Family Medicine”, the third column shows his rating as 4.5 out of 6 ratings provided by previous patients or consumers, the fourth column shows his cost as $100.00, the fifth column shows his years of service as “6”. Information concerning a second recommended provider, “Dr. Jack Wall”, is shown in the second provider column in the chart, table, or listing 1510.

Section 1512 includes text stating “All Available Providers”. The section 1512 refers to the chart or table 1514 which lists all available providers, for example all providers that are registered or participating in the TMED web site service. The chart 1514 includes information for four providers in the example of FIG. 15. The categories of information for the providers in the chart 1514 may be similar to or identical to the categories shown in the chart 1510. The patient/consumer may select one of the recommended providers or may select from any of the available providers.

FIG. 16 shows an image 1600 for display on the computer/device display 208 of the patient/consumer computer/device 200 by the computer/device processor 206 of FIG. 2 in accordance with an embodiment of the present invention. The image 1600 may be a rendering of a secondary web site page which is downloaded from the server computer/device 102 to the patient/consumer computer/device 200 relating to a web site called the TMED (trademarked) web site. The image 1600 may be displayed by the computer/device processor 206 on the computer/device display 208 after a patient/consumer selects, using the computer/device interactive device 204 of the patient/consumer computer/device 200, the section or link 1310 (“Enter Appointment Waiting Room”) or the “Take Action” link to the right of the first line under “Confirmed Appointments” section 1314 in the image 1300 of FIG. 13. The image 1600 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1600 shown in FIG. 16, includes a section 1602 showing the trademark TMED and symbol. The image 1600 further includes section, fields, portions, or buttons 1604, 1606, 1608, 1610, 1612, 1614, 1616, 1618, and 1620. Section 1604 includes text “Welcome Richard” which indicates that the patient/consumer's name is “Richard” and welcomes the patient/consumer to the TMED (trademarked) web site. Section 1604 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1500 is taken off of the computer/device display 208 and the patient/consumer no longer is using the TMED (trademarked) web site.

Section 1606 includes text which indicates that the image 1600 relates to a “Waiting Room” for “Dr. Joe Smith” web page which came from, or was entered through the “Enter Waiting Room” link 1310, and/or the section of provider Joe Smith through the chart 1510, first provider row “Select” button in FIG. 15, and an indication of “Home” to indicate that the starting point for the web site is the home page related to image 1300 for the TMED (trademarked) web site.

Section 1608 includes a box which may show a live view of the patient/consumer, in this case live video feed of “Richard”. This view shows the patient/consumer the video image that will be provided and displayed also on the provider's computer/device 300. “Richard” may be using patient/consumer computer/device 200 and may also be using a computer/device interactive device 204 which may include a camera for providing live video feed of Richard to section 1608 of the computer/device display 208 of the patient/consumer computer/device 200, via computer/device processor 206. Section 1610 includes an image and text stating “Test Video Conference”. Section 1610 can be selected by computer/device interactive device 204 of the patient/consumer computer/device 200 to generate a web page, not shown, which will initiate a diagnostic test to check a patient/consumer's device 200 video conferencing capabilities. Section 1612 includes an image and text stating “Request Call”. Section 1612 can be selected by computer/device interactive device 204 of the patient/consumer computer/device 200 to generate a web page, not shown, that allows a patient/consumer to enter and submit a phone number that the TMED server computer/device 102 will call when it is the patient/consumers turn. The patient/consumer may receive a computer generate call indicating that the patient/consumer should return to the patient/consumer computer/device 200 to begin the video consultation. The patient/consumer may be provided an option to select a telephone conference with the provider instead of a video conference by pressing a telephone key or verbally responding to interactive voice response system, in which case the server computer/device 102 will connect the call to the provider, such as to provider computer/device 300. This option gives patient/consumers the flexibility to be away from their patient/consumer computer/device 200 while waiting for a provider or practice to respond. It also mitigates technical device related problems that would prevent a patient/consumer from “seeing” a provider.

Section 1614 includes an image and text stating “Exiting Waiting Room”. Section 1614 can be selected by computer/device interactive device 204 of the patient/consumer computer/device 200 to generate a web page, downloaded from the server computer/device 102 which returns the patient/consumer to the web page on FIG. 13.

Section 1616 is a window which shows various information concerning a current appointment with Dr. Joe Smith. Section 1616 may show a live video feed of the actual provider, in this case live video feed of “Dr. Joe Smith” once the consultation begins, at which time the various information concerning the appointment will no longer be displayed. “Dr. Joe Smith” may be using provider computer/device 300 and may also be using a computer/device interactive device 304 which may include a camera for providing live video feed of Dr. Joe Smith to section 1616 of the computer/device display 208 of the patient/consumer computer/device 200, via computer/device processor 306, port 310, internet 106, port 210 and computer/device processor 206.

Section 1618 may be a window in which a chat may take place between the patient/consumer and the provider, in this case Dr. Joe Smith. Text of back and forth dialogue between Dr. Joe Smith and the patient/consumer may be displayed in the window 1618. The patient/consumer may type in, or otherwise input, their questions or responses using computer/device interactive device 204 which then may be sent by computer/device processor 206 to the provider computer/device 300 of Dr. Joe Smith, via port 210, internet 106, port 310, and computer/device processor 306. As these questions or responses are input, they may be displayed on computer/device display 208 in window 1618. Dr. Joe Smith may provide questions or responses through computer/device interactive device 304 and those may be provided to patient/consumer computer/device 200 through internet 106, port 210, and caused to be displayed on computer/device display 208 by computer/device processor 206.

Section 1620 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

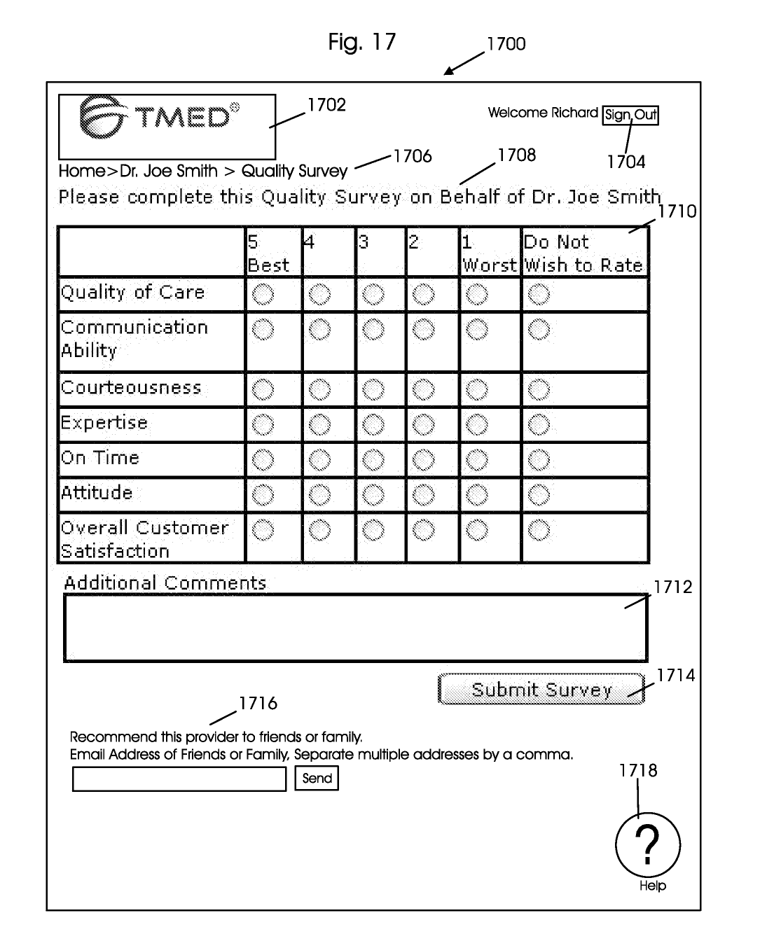

FIG. 17 shows an image 1700 for display on the computer/device display 208 of the patient/consumer computer/device 200 by the computer/device processor 206 of FIG. 2 in accordance with an embodiment of the present invention. The image 1700 may be a rendering of a secondary web site page which is downloaded from the server computer/device 102 to the patient/consumer computer/device 200 relating to a web site called the TMED (trademarked) web site. The image 1700 may be displayed by the computer/device processor 206 on the computer/device display 208 after a patient/consumer ends a consultation with a provider at which time the image 1700 is dynamically rendered by the server computer/device 102. The image 1700 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1700 shown in FIG. 17, includes a section 1702 showing the trademark TMED and symbol. The image 1700 further includes section, fields, portions, or buttons 1704, 1706, 1708, 1710, 1712, 1714, 1716, and 1718. Section 1704 includes text “Welcome Richard” which indicates that the patient/consumer's name is “Richard” and welcomes the patient/consumer to the TMED (trademarked) web site. Section 1704 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1700 is taken off of the computer/device display 208 and the patient/consumer no longer is using the TMED (trademarked) web site.

Section 1706 includes text which indicates that the image 1700 relates to a “Quality Survey” for “Dr. Joe Smith” web page which may be displayed by the computer/device processor 206 on the computer/device display 208 after a patient/consumer ends a consultation with a provider at which time the image 1706 is dynamically rendered by the server computer/device 102 and an indication of “Home” to indicate that the starting point for the web site is the home page related to image 1300 for the TMED (trademarked) web site.

Section 1708 includes text stating “Please complete this Quality Survey on Behalf of Dr. Joe Smith”. Section 1710 includes a chart having a plurality of rows and columns. The first row is blank in the first column and indicates ratings of “5 Best”, “4”, “3”, “2”, and “1 Worst” in the next five columns. The title row, last column indicates “Do Not Wish to Rate”. The following rows in the first column have various items which are rated, such as “Quality of Care”, “Communication Ability”, etc. for this provider (Dr. Joe Smith), as rated by the patient/consumer (Richard). Each column in the particular item row, has a circle which can be selected by a patient/consumer using computer/device interactive device 204 to rate the provider with respect to the particular item. For example, the patient/provider may click on the circle under “5 Best” in the “Quality of Care” item row to rate Dᵣ. Joe Smith as having the best (at “5”) quality of care using computer/device interactive device 204 of the computer/device 200. The patient/consumer would click on only one circle of the circles under columns for “5” through “1” and “Do Not Wish to Rate” for each item row to rate the particular provider. Section 1712 is a window into which the patient/consumer can type or otherwise enter additional comments concerning the provider Dr. Joe Smith. Section 1714 when selected using the computer/device interactive device 204 causes the computer/device processor 206 to submit the information entered into the sections 1710 and 1712 to the server computer/device 102 via the port 210 and the internet 106. Section 1716 allows a patient/consumer to enter other email addresses of friends or family, to whom, the patient/consumer may recommend the particular provider, into the blank box shown in section 1716. Section 1716 also includes a box with “Send” which can be selected using computer/device interactive device 204 to cause the computer/device processor 206 send the email addresses to the server computer/device 102 through the port 210 and the internet 106. Results of the survey and referral are stored in the matching engine database, which may be located in computer memory of server computer/device 102.

Section 1718 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

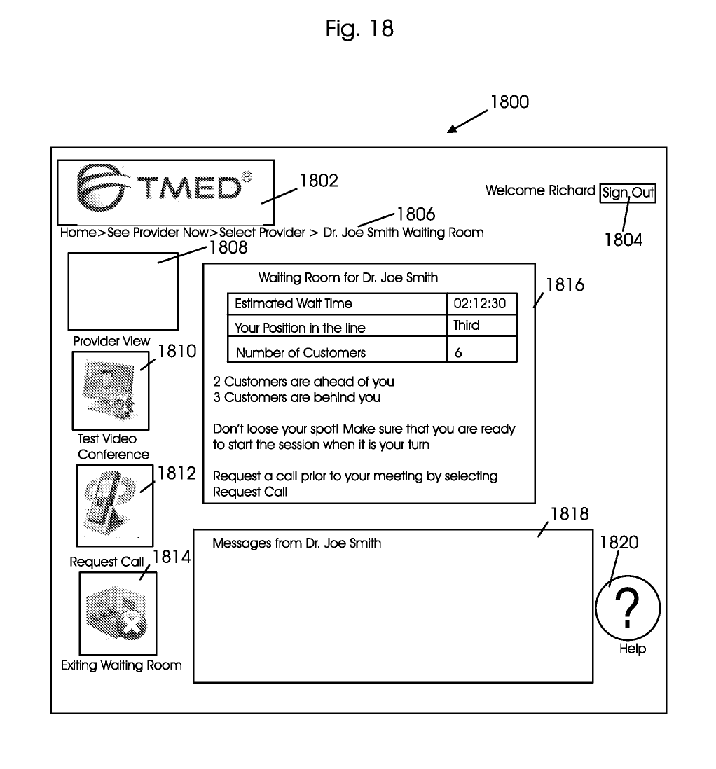

FIG. 18 shows an image 1800 for display on the computer/device display 208 of the patient/consumer computer/device 200 by the computer/device processor 206 of FIG. 2 in accordance with an embodiment of the present invention. The image 1800 may be a rendering of a secondary web site page which is downloaded from the server computer/device 102 to the patient/consumer computer/device 200 relating to a web site called the TMED (trademarked) web site. The image 1800 may be displayed by the computer/device processor 206 on the computer/device display 208 after a patient/consumer selects, using the computer/device interactive device 204 of the patient/consumer computer/device 200, the “Select” button in the first provider row of the “See Provider Now No Appointment Needed” rendering of chart 1510 shown in FIG. 15 The image 1800 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1800 shown in FIG. 18, includes a section 1802 showing the trademark TMED and symbol. The image 1800 further includes section, fields, portions, or buttons 1804, 1806, 1808, 1810, 1812, 1814, 1816, 1818, and 1820. Section 1804 includes text “Welcome Richard” which indicates that the patient/consumer's name is “Richard” and welcomes the patient/consumer to the TMED (trademarked) web site. Section 1804 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1800 is taken off of the computer/device display 208 and the patient/consumer no longer is using the TMED (trademarked) web site.

Section 1806 includes text which indicates that the image 1800 relates to “Dr. Joe Smith Waiting Room” web page which came from, or was entered through the “Select Provider” web page of FIG. 15, and/or the section of provider Joe Smith through the chart 1510, first provider row “Select” button in FIG. 15, and/or the “See provider Now” link 1306 of FIG. 13, and an indication of “Home” to indicate that the starting point for the web site is the home page related to image 1300 for the TMED (trademarked) web site.

Section 1808 includes a box which may show a live view of the patient/consumer, in this case live video feed of “Richard”. This view shows the patient/consumer the video image that will be displayed on the provider's computer/device 300. “Richard” may be using provider computer/device 200 and may also be using a computer/device interactive device 204 which may include a camera for providing live video feed of Richard to section 1808 of the computer/device display 208 of the patient/consumer computer/device 200, via computer/device processor 206. Section 1810 includes an image and text stating “Test Video Conference”. Section 1810 can be selected by computer/device interactive device 204 of the patient/consumer computer/device 200 to generate a web page, not shown, which can be downloaded from the server computer/device 102, which will initiate a diagnostic test to check a patient/consumer's device 200 video conferencing capabilities. Section 1812 includes an image and text stating “Request Call”. Section 1812 can be selected by computer/device interactive device 204 of the patient/consumer computer/device 200 to generate a web page, not shown, that can be downloaded from the server computer/device 102 that allows a patient/consumer to enter and submit a phone number that the TMED server computer/device 102 will call when it is the patient/consumers turn. The patient/consumer may receive a computer generated call indicating that the patient/consumer should return to the patient/consumer device 200 to begin the video consultation. The patient/consumer may be provided an option to select a telephone conference with the provider instead of a video conference by pressing a telephone key or verbally responding to interactive voice response system, in which case the server computer/device 102 will connect the call to the provider computer/device 300. This option gives patients/consumers the flexibility to be away from their patient/consumer computer/device 200 while waiting for a provider or practice. It also mitigates technical device related problems that would prevent a patient/consumer from “seeing” a provider.

Section 1814 includes an image and text stating “Exiting Waiting Room”. Section 1814 can be selected by computer/device interactive device 204 of the patient/consumer computer/device 200 to generate a web page, such as by downloading from the server computer/device 102 which returns the patient/consumer computer/device 200 to the web page on FIG. 13 (i.e. the web page or image of FIG. 13 is displayed on the computer/device display 208).

Section 1816 is a window which shows various information concerning a waiting room for Dr. Joe Smith. The information in section 1816 may be constantly automatically updated by the server computer/device 102 providing updated information to the patient/consumer computer/device 200. The information in section 1816 may include a table having an estimated wait time, a position in line (or in the queue), and a number of customers in the virtual waiting room, for the patient/customer (Richard) who is waiting in the virtual waiting room, i.e. in this case “Richard” who is using the patient/customer computer/device 200. The estimated wait time, position in line, and number of customers in the waiting room may be constantly updated by the server computer/device 102 updating the window 1806 on the computer/device display 208 via the internet 106 the port 210 and the server computer/device 206. The window 1816 also may include the number of customers, consumers, or patients ahead of this particular patient/consumer (i.e. ahead of Richard), and the number of customers behind the particular patient/consumer, and these quantities may also be updated by the server computer/device 102 updating the window 1816. There may also be various text in the window 1816 advising this particular consumer or patient of various matters. Section 1816 may show a live video feed of the actual provider, in this case live video feed of “Dr. Joe Smith” once the consultation begins, at which time the various information concerning the appointment will no longer be displayed. “Dr. Joe Smith” may be using provider computer/device 300 and may also be using a computer/device interactive device 304 which may include a camera for providing live video feed of Dr. Joe Smith to section 1816 of the computer/device display 208 of the patient/consumer computer/device 200, via computer/device processor 306, port 310, internet 106, port 210 and computer/device processor 206.

Section 1818 is a window which may show messages from Dr. Joe Smith. Dr. Joe Smith may input messages into computer/device interactive device 304 and these messages may be sent to the patient/consumer computer/device 200 via computer/device processor 306, port 310, internet 106, port 210 and computer/device processor 206, and displayed on the computer/device display 208.

Section 1820 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

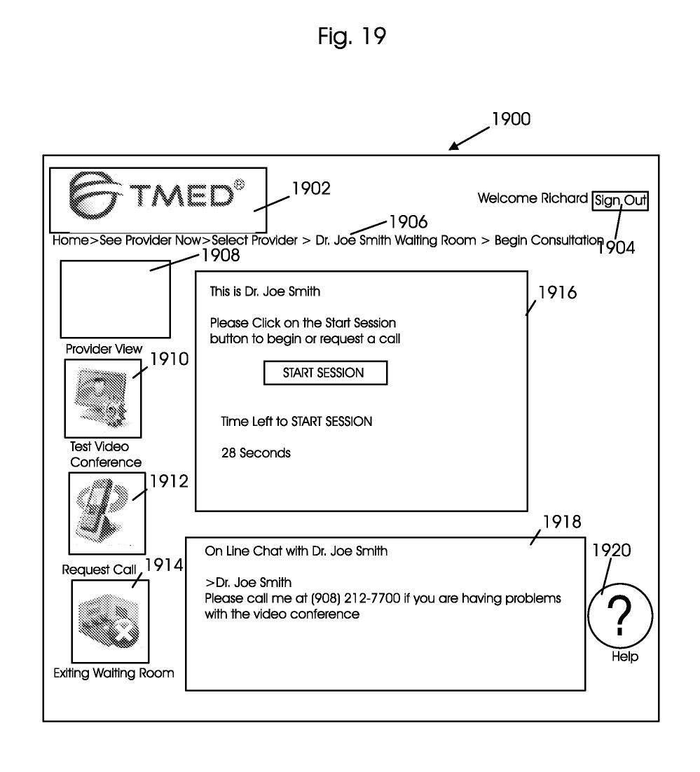

FIG. 19 shows an image 1900 for display on the computer/device display 208 of the patient/consumer computer/device 200 by the computer/device processor 206 of FIG. 2 in accordance with an embodiment of the present invention. The image 1900 may be a rendering of a secondary web site page which is downloaded from the server computer/device 102 to the patient/consumer computer/device 200 relating to a web site called the TMED (trademarked) web site. The image 1900 may be displayed by the computer/device processor 206 on the computer/device display 208 after a patient/consumer selects, using the computer/device interactive device 204 of the patient/consumer computer/device 200 is rendered by the server 102 when it is the patient/consumers turn to “see” a provider.

The image 1900 may be a rendering of an HTML (hypertext markup language) web site page downloaded from the server computer/device 102, via port 210 and internet 106 to the computer/device processor 206, and rendered and interpreted by browser computer/device software stored in computer/device memory 202 and running on the computer/device processor 206.

The image 1900 shown in FIG. 19, includes a section 1902 showing the trademark TMED and symbol. The image 1900 further includes section, fields, portions, or buttons 1904, 1906, 1908, 1910, 1912, 1914, 1916, 1918, and 1920. Section 1904 includes text “Welcome Richard” which indicates that the patient/consumer's name is “Richard” and welcomes the patient/consumer to the TMED (trademarked) web site. Section 1904 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 1900 is taken off of the computer/device display 208 and the patient/consumer no longer is using the TMED (trademarked) web site.

Section 1906 includes text which indicates that the image 1900 relates to “Begin Consultation” web page which came from the “Dr. Joe Smith Waiting Room” web page which came from, or was entered through the “Select Provider” web page of FIG. 15, and/or the section of provider Joe Smith through the chart 1510, first provider row “Select” button in FIG. 15, and/or the “See provider Now” link 1306 of FIG. 13, and an indication of “Home” to indicate that the starting point for the web site is the home page related to image 1300 for the TMED (trademarked) web site.

Section 1908 includes a box which may show a live view of the patient/consumer, in this case live video feed of “Richard”. This view shows the patient/consumer the video image that will be displayed on the provider's computer/device 300. “Richard” may be using provider computer/device 200 and may also be using a computer/device interactive device 204 which may include a camera for providing live video feed of Richard to section 1908 of the computer/device display 208 of the patient/consumer computer/device 200, via computer/device processor 206. Section 1910 includes an image and text stating “Test Video Conference”. Section 1910 can be selected by computer/device interactive device 204 of the patient/consumer computer/device 200 to generate a web page, not shown, downloaded from the server computer/device 102, which will initiate a diagnostic test to check a patient/consumer's device 200 video conferencing capabilities. Section 1912 includes an image and text stating “Request Call”. Section 1912 can be selected by computer/device interactive device 204 of the patient/consumer computer/device 200 to generate a web page, not shown, that allows a patient/consumer to enter and submit a phone number that the TMED server computer/device 102 will call when it is the patient/consumers turn. The patient/consumer may receive a computer generated call, at a telephone of the patient/consumer indicating that the patient/consumer should return to the patient/consumer computer/device 200 to begin the video consultation. The patient/consumer may be provided an option to select a telephone conference with the provider instead of a video conference by pressing a telephone key, on a telephone, or verbally responding to interactive voice response system, in which case the server computer/device 102 will connect the call to the provider. This option gives patient/consumers the flexibility to be away from their patient/consumer computer/device 200 while waiting for a provider or practice. It also mitigates technical device related problems that would prevent a patient/consumer from “seeing” a provider. Section 1914 includes an image and text stating “Exiting Waiting Room”. Section 1914 can be selected by computer/device interactive device 204 of the patient/consumer computer/device 200 to generate a web page which returns the patient/consumer to the web page shown in FIG. 13.

Section 1916 is a window through which a patient/consumer can begin a session with a provider, such as in this example “Dr. Joe Smith”. The window shows the text “Please Click on the Start Session button to begin or request a call” and provides identifying text above that for “Dr. Joe Smith”. A patient/consumer can select the box with the “Start Session” text in it in window 1916 to being a session with Dr. Joe Smith by using computer/device interactive device 204 of the patient/consumer computer/device 200. The window 1916 also shows a time limit for starting a session with a provider (in this Dr. Joe Smith) which may count down from a certain time and which may be provided to the patient/consumer computer/device 200 and updated and/or counted down by the server computer/device 102. Section 1916 may show a live video feed of the actual provider, in this case live video feed of “Dr. Joe Smith” once the consultation begins, at which time the various information concerning the appointment will no longer be displayed. Section 1916 may show a live video feed of the actual provider, in this case live video feed of “Dr. Joe Smith”. “Dr. Joe Smith” may be using provider computer/device 300 and may also be using a computer/device interactive device 304 which may include a camera for providing live video feed of Dr. Joe Smith to section 1908 of the computer/device display 208 of the patient/consumer computer/device 200, via computer/device processor 306, port 310, internet 106, port 210 and computer/device processor 206.

Section 1918 may show communications back and forth or a chat session between the provider (Dr. Joe Smith) using provider computer/device 300 and the patient/consumer using patient/consumer computer/device 200.

Section 1920 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

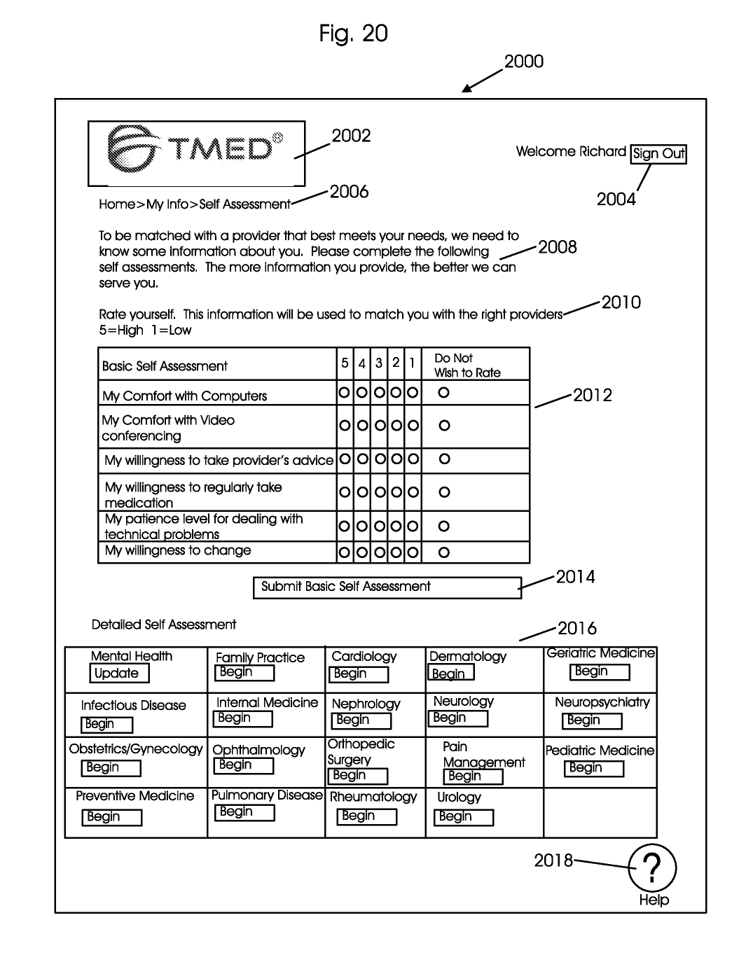

FIG. 20 shows an image 2000 for display on the computer/device display 208 of the patient/consumer computer/device 200 by the computer/device processor 206 of FIG. 2 in accordance with an embodiment of the present invention. The image 2000 may be a rendering of a secondary web site page which is downloaded from the server computer/device 102 to the patient/consumer computer/device 200 relating to a web site called the TMED (trademarked) web site. The image 2000 may be displayed by the computer/device processor 206 on the computer/device display 208 after a patient/consumer selects the “My Info” icon or section 1312 in FIG. 13, using the computer/device interactive device 204 of the patient/consumer computer/device 200, when the patient/consumer completes the registration process identified in FIG. 6A or when the patient/consumer select an “Alert” hyperlink in FIG. 13.

The image 2000 may be a rendering of an HTML (hypertext markup language) web site page downloaded from the server computer/device 102, via port 210 and the internet 106 to the computer/device processor 206, and rendered and interpreted by browser computer/device software stored in computer/device memory 202 and running on the computer/device processor 206.

The image 2000 shown in FIG. 20, includes a section 2002 showing the trademark TMED and symbol. The image 2000 further includes section, fields, portions, or buttons 2004, 2006, 2008, 2010, 2012, 2014, 2016, and 2018. Section 2004 includes text “Welcome Richard” which indicates that the patient/consumer's name is “Richard” and welcomes the patient/consumer to the TMED (trademarked) web site. Section 2004 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 2000 is taken off of the computer/device display 208 and the patient/consumer no longer is using the TMED (trademarked) web site.

Section 2006 includes text which indicates that the image 2000 relates to “Self Assessment” web page and came from a “My Info” web page and an indication of “Home” to indicate that the starting point for the web site is the home page related to image 1300 for the TMED (trademarked) web site.

Section 2008 includes text related to instructions concerning the self assessment web page of FIG. 20. Section 2010 includes text related to instructions concerning ratings. Section 2012 includes a table of rows and columns including a heading row and a plurality of basic self assessment row items for a patient/consumer to provide rating regarding. For example the second row, or first assessment item row states “My Comfort with Computer/devices” in the first column. The next six columns of the first assessment item row (second row overall) show circles under the headings “5”, “4”, “3”, “2”, “1”, and “Do Not Wish to Rate”. A patient/consumer using the computer/device interactive device 204 of the patient/consumer computer/device 200 can fill in one of the circles in one of the columns for each self assessment item to indicate a rating for each self assessment item. The patient/consumer can then submit the ratings to the server computer/device 102 by selecting the “Submit Basic Self Assessment” box or section 2014 by using computer/device interactive device 204 of the patient/consumer computer/device 200.

Section 2016 provides a table for detailed self assessment for a patient/consumer for a particular specialty or health area. The table 2016 has a plurality of rows and columns forming a grid of items. Each item can be selected and then detailed information regarding that item can be provided. For example, a user can select a “Begin” button in the first row, second column item in section or table 2106 to provide information regarding family practice. This will cause an additional web page, not shown, to be downloaded from the server computer/device 102 and displayed on the computer/device display 208. The user can then enter detailed information concerning his or herself concerning their family practice preferences or characteristics.

Section 2018 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

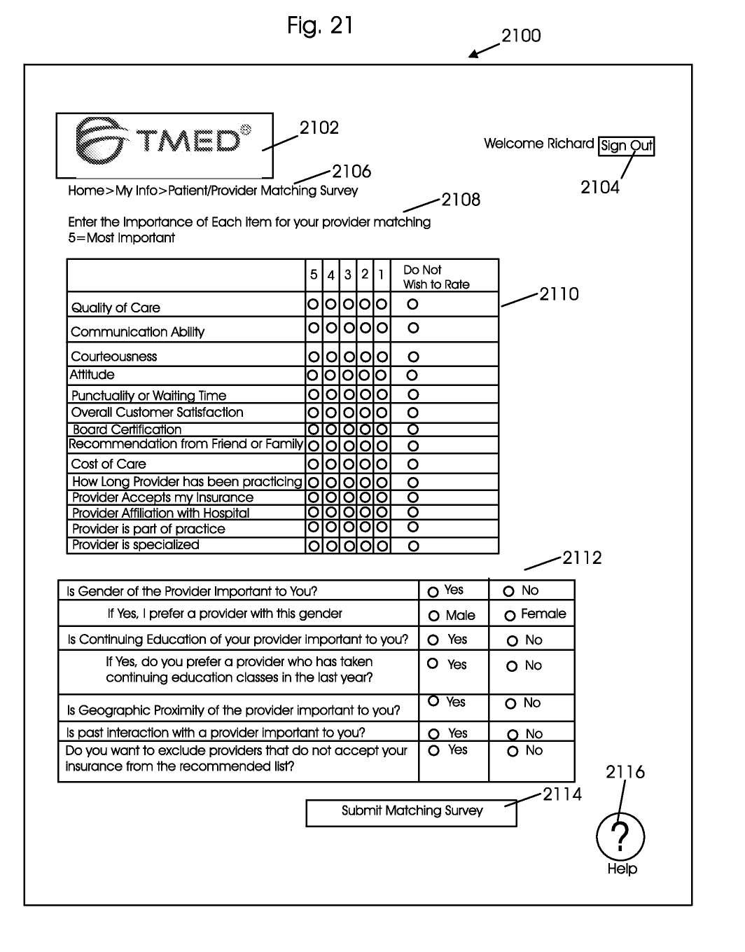

FIG. 21 shows an image 2100 for display on the computer/device display 208 of the patient/consumer computer/device 200 by the computer/device processor 206 of FIG. 2 in accordance with an embodiment of the present invention. The image 2100 may be a rendering of a secondary web site page which is downloaded from the server computer/device 102 to the patient/consumer computer/device 200 relating to a web site called the TMED (trademarked) web site. The image 2100 may be displayed by the computer/device processor 206 on the computer/device display 208 after a patient/consumer selects the “My Info” icon or section 1312 in FIG. 13, using the computer/device interactive device 204 of the patient/consumer computer/device 200, when the patient/consumer completes the registration process identified in FIG. 6A or when the patient/consumer select an “Alert” hyperlink in FIG. 13.

The image 2100 may be a rendering of an HTML (hypertext markup language) web site page downloaded from the server computer/device 102, via port 210 and the internet 106 to the computer/device processor 206, and rendered and interpreted by browser computer/device software stored in computer/device memory 202 and running on the computer/device processor 206.

The image 2100 shown in FIG. 21, includes a section 2102 showing the trademark TMED and symbol. The image 2100 further includes section, fields, portions, or buttons 2104, 2106, 2108, 2110, 2112, 2114, and 2116. Section 2104 includes text “Welcome Richard” which indicates that the patient/consumer's name is “Richard” and welcomes the patient/consumer to the TMED (trademarked) web site. Section 2104 also includes a button or box, in which is located the text “Sign Out” and which when clicked on using for example a computer/device mouse of the computer/device interactive device 204 of the patient/consumer computer/device 200, causes the TMED (trademarked) web site to be exited so that the image 2100 is taken off of the computer/device display 208 and the patient/consumer no longer is using the TMED (trademarked) web site.

Section 2106 includes text which indicates that the image 2100 relates to “A Provider Matching Survey” web page and came from a “My Info” web page and an indication of “Home” to indicate that the starting point for the web site is the home page related to image 1300 for the TMED (trademarked) web site.

Section 2108 includes text related to instructions concerning the provider matching survey. Section 2110 includes a table of rows and columns including a heading row and a plurality of survey row items for a patient/consumer to provide ratings regarding. For example the second row, or first survey item row states “Quality of Care” in the first column. The next six columns of the first survey item row (second row overall) show circles under the headings “5”, “4”, “3”, “2”, “1”, and “Do Not Wish to Rate”. A patient/consumer using the computer/device interactive device 204 of the patient/consumer computer/device 200 can fill in one of the circles in one of the columns for each survey item to indicate a rating for each survey item. The patient/consumer can then submit the ratings to the server computer/device 102 by selecting the “Submit Matching Survey” box or section 2114 by using computer/device interactive device 204 of the patient/consumer computer/device 200.

Section 2112 provides a table for further questions for the matching survey. The patient/consumer can fill in a circle next to either “Yes” or “No”, or a circle for “Male” or “Female” as appropriate to provide answers to the further questions shown in section or table 2112. The answers to the questions in section 2112 are also submitted to the server computer/device 102 by the patient/consumer computer/device 200 in response to selection of the “Submit matching Survey” box 2114 by using computer/device interactive device 204.

Section 2116 may include a help button which can be clicked on using a computer/device mouse, or otherwise selected by the computer/device interactive device 204 to cause the computer/device processor 206 to request a help web page from the server computer/device 102 which would then be displayed on the computer/device display 208.

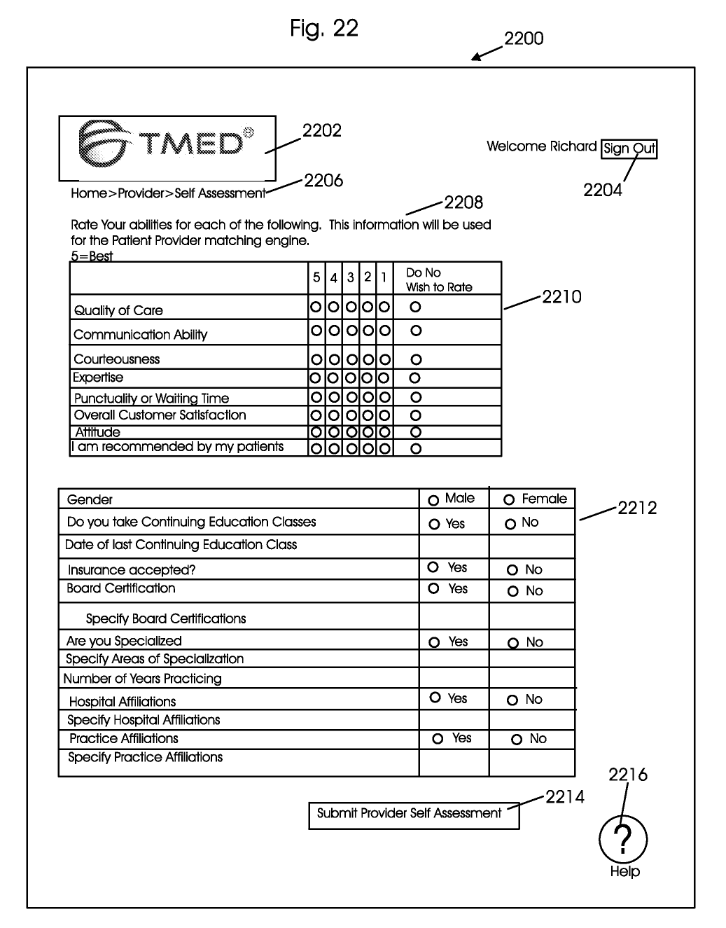

FIG. 22 shows an image 2200 for display on the computer/device display 208 of the provider computer/device 300 by the computer/device processor 306 of FIG. 3 in accordance with an embodiment of the present invention. The image 2200 may be a rendering of a secondary web site page which is downloaded from the server computer/device 102 to the provider computer/device 300 relating to a web site called the TMED (trademarked) web site. The image 2200 may be displayed by the computer/device processor 306 on the computer/device display 308 after a provider (such as Dr. Joe Smith) selects the “My Info” icon or section 1312 in FIG. 13, using the computer/device interactive device 304 of the provider computer/device 300, when the provider completes the registration process identified in FIG. 5 and FIG. 9 or when the provider select an “Alert” hyperlink from a provider rendering of FIG. 13.

The image 2200 may be a rendering of an HTML (hypertext markup language) web site page downloaded from the server computer/device 102, via port 310 and the internet 106 to the computer/device processor 306, and rendered and interpreted by browser computer/device software stored in computer/device memory 302 and running on the computer/device processor 306 of the provider computer/device 300.

The image 2200 shown in FIG. 22, includes a section 2202 showing the trademark TMED and symbol. The image 2200 further includes section, fields, portions, or buttons 2204, 2206, 2208, 2210, 2212, 2214, and 2216. Section 2204 includes text “Welcome Richard” which indicates that the patient/consumer's name is “Richard” and welcomes the patient/consumer to the TMED (trademarked) web site. Section 2204 also includes a button or box, in which is located the text “Sign Out” and which when clicked on using for example a computer/device mouse of the computer/device interactive device 304 of the provider computer/device 300, causes the TMED (trademarked) web site to be exited so that the image 2200 is taken off of the computer/device display 308 and the provider no longer is using the TMED (trademarked) web site.

Section 2206 includes text which indicates that the image 2200 relates to “Self Assessment”, “Provider” web page and an indication of “Home” to indicate that the starting point for the web site is the home page related to image 1300 for the TMED (trademarked) web site.

Section 2208 includes text related to instructions concerning the provider self assessment. Section 2210 includes a table of rows and columns including a heading row and a plurality of provider self assessment row items for a provider to provide ratings regarding. For example the second row, or first assessment item row states “Quality of Care” in the first column. The next six columns of the first survey item row (second row overall) show circles under the headings “5”, “4”, “3”, “2”, “1”, and “Do Not Wish to Rate”, respectively. A provider using the computer/device interactive device 304 of the provider computer/device 300 can fill in one of the circles in one of the columns for each survey item to indicate a rating for each assessment item. The provider can then submit the ratings to the server computer/device 102 by selecting the “Submit Provider Self Assessment” box or section 2214 by using computer/device interactive device 304 of the provider computer/device 300.

Section 2212 provides a table for further questions for the provider self assessment. The provider can fill in a circle next to either “Yes” or “No”, or a circle for “Male” or “Female” as appropriate to provide answers to the further questions shown in section or table 2212. The provider can also input, using computer/device interactive device 304, further information, such as board certifications, as indicated in section 2212. The answers to the questions in section 2212 are also submitted to the server computer/device 102 by the provider computer/device 300 in response to selection of the “Submit Provider Self Assessment” box 2214 by using computer/device interactive device 304.

Section 2216 may include a help button which can be clicked on using a computer/device mouse, or otherwise selected by the computer/device interactive device 304 to cause the computer/device processor 306 to request a help web page from the server computer/device 102 which would then be displayed on the computer/device display 308.

FIG. 23 shows a dedicated computer/device 2300 for a touch screen implementation of consumer/patient interactive device 200. The dedicated computer/device 2300 may be a portable wireless device. The dedicated computer/device 2300 may have a housing 2301, and a computer touch screen 2303 on which an image 2303a is shown. The dedicated computer/device 2300 may be optimized for the TMED processes defined in this application. The dedicated computer/device 2300 may have a video camera, a microphone, wired and wireless communications capabilities to connect to the internet, wired and wireless communication capabilities to connect and collect data from other related devices, such as a glucose meter or a pedometer. The collected data may be added to the patient/consumers electronic medical record (EMR)/personal health record (PHR). The microphone and video camera may be used to enable bio-metric security of the dedicated computer/device 2300 and the TMED computer software application running on the server computer/device 102. A video camera of the dedicated computer/device 2300 may be used for facial recognition or for fingerprint recognition security. A microphone of the dedicated computer/device 2300 may be used for voice recognition security. Not pictured, a dedicated finger print reader may be integrated with the dedicated computer/device 2300 for fingerprint recognition security. The dedicated computer/device 2300 may have integrated encryption hardware and/or software to optimize video conference security and performance. The dedicated computer/device 2300 may have a series of integrated light emitting diodes (LED) or similar lighting across the front of the computer/device display where the intensity is controlled by the patient/consumer to enhance the quality of the video capture.

FIG. 23 shows an image 2303a for display on the display 2303 of the patient/consumer dedicated computer/device 2300 by a computer/device processor, not shown, which may be similar or identical to computer processor 206 of FIG. 2 in accordance with an embodiment of the present invention. The image 2303a may be a rendering of a home web site page which is downloaded from the server computer/device 102 to the patient/consumer dedicated computer/device 2300 for a web site called the TMED (trademarked) web site. The image 2303a may appear on the computer/device display or screen 2303 after a patient/consumer inputs a web site address for the TMED web site home page into a computer/device interactive device, similar to or identical to 204 of FIG. 2, which is then sent via a processor, similar to or identical to 206, port, similar to or identical to 210, and internet 106 to access the TMED web site home page. The web site home page may include an HTML (hypertext markup language) file which is rendered into the image 2303a by computer/device browser software stored in the computer/device memory of device 2300 (similar or identical to memory 202) and running on a computer/device processor of the device 2300, similar to or identical to processor 206.

The device 2300 has a section 2302 which may be on a screen or may me a label or solid piece which shows the trademarked symbol TMED and logo.

The image 2303a shown in FIG. 23 includes sections, fields, portions, or buttons 2304, 2306, 2308, 2310, 2312, 2314, 2316, and 2318, which may be similar or identical to sections 1304, 1306, 1308, 1310, 1312, 1314, 1316, and 1318, respectively, shown and described with reference to FIG. 13.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
providing a first web page from a first server computer to a patient/consumer computer via the internet;
wherein the first web page when rendered on a patient/consumer computer display of the patient/consumer computer by an internet browser computer program running on the patient/consumer computer, displays a menu including a first set of selectable items;
wherein the first set of selectable items includes a first link which when selected using a computer interactive device of the patient/consumer computer, sends a first set of information to the first server computer, wherein the first set of information relates to setting up a first communication session between a first provider of medical services and/or goods and the patient/consumer; and
further comprising receiving the first set of information at the first server computer and causing the first communication session to be set up between the first provider of medical services and/or goods and the patient/consumer.

2. The method of claim 1 further comprising
providing a second web page from the first server computer to the patient/consumer computer via the internet;
wherein the second web page when rendered on a patient/consumer computer display of the patient/consumer computer by an internet browser computer program running on the patient/consumer computer, displays information indicating that the patient/consumer has to wait for a period of time before having the first communication session.

3. The method of claim 1 wherein
wherein the first web page when rendered on a patient/consumer computer display of the patient/consumer computer by an internet browser computer program running on the patient/consumer computer, displays information concerning a plurality of scheduled communication sessions between the patient/consumer and a provider of medical services and/or goods, wherein each of the plurality of scheduled communication sessions is scheduled to occur at a future time.

4. The method of claim 1 wherein
wherein the first web page when rendered on a patient/consumer computer display of the patient/consumer computer by an internet browser computer program running on the patient/consumer computer, displays a link for accessing a web page having a patient self assessment form, into which the patient/consumer can enter information concerning characteristics of the patient/consumer.

5. The method of claim 1 wherein
the characteristics of the patient/consumer include the health history of the patient/consumer as recalled by the patient/consumer.

6. The method of claim 1 wherein
wherein the first web page when rendered on a patient/consumer computer display of the patient/consumer computer by an internet browser computer program running on the patient/consumer computer, displays a link for accessing a web page having a provider quality survey form, into which the patient/consumer can enter information concerning the patient/consumer's opinions about the first provider of medical services and/or goods.

7. The method of claim 1 further comprising
providing a second web page having a list of selectable providers of medical services and/or goods; and
setting up the first communication session between the first provider of medical services and/or goods in response, at least in part, to a selection by the patient/consumer using the computer interactive device of the patient/consumer computer, of the first provider of medical services and/or goods from the list of selectable providers of medical services and/or goods.

8. The method of claim 1 further comprising
providing a second web page from the first server computer to the patient/consumer computer via the internet;
wherein the second web page when rendered on a patient/consumer computer display of the patient/consumer computer by an internet browser computer program running on the patient/consumer computer, provides information concerning the first communication session while the first communication session is taking place.

9. The method of claim 8 further comprising the information concerning the first communication session while the first communication session is taking place includes video of the first provider of medical services and/or goods.

10. The method of claim 8 further comprising the information concerning the first communication session while the first communication session is taking place includes video of the patient/consumer.

11. The method of claim 8 further comprising the information concerning the first communication session while the first communication session is taking place includes text of communications made by the patient/consumer and text of communications made by the provider of medical services and/or goods displayed on the patient/consumer display.

12. The method of claim 1 further comprising
using the first server computer to retrieve an electronic medical record of the patient/consumer via the internet from an electronic medical record computer;
and providing information concerning the electronic medical record of the patient/consumer to the first provider of medical services and/or goods.

13. An apparatus comprising
a first server computer which hosts one or more web pages for a web site for setting up communication sessions between patient/consumers and one or more providers of medical services and/or goods;
wherein the first server computer is programmed to provide a first web page of the web site from the first server computer to a patient/consumer computer via the internet;
wherein the first web page when rendered on a patient/consumer computer display of the patient/consumer computer by an internet browser computer program running on the patient/consumer computer, displays a menu including a first set of selectable items;
wherein the first set of selectable items includes a first link which when selected using a computer interactive device of the patient/consumer computer, sends a first set of information to the first server computer, wherein the first set of information relates to setting up a first communication session between a first provider of medical services and/or goods and the patient/consumer; and
wherein the first server computer is programmed to receive the first set of information at the first server computer and to cause the first communication session to be set up between the first provider of medical services and/or goods and the patient/consumer.

14. The apparatus of claim 13 wherein
the first server computer is programmed to provide a second web page from the first server computer to the patient/consumer computer via the internet;
wherein the second web page when rendered on a patient/consumer computer display of the patient/consumer computer by an internet browser computer program running on the patient/consumer computer, displays information indicating that the patient/consumer has to wait for a period of time before having the first communication session.

15. The apparatus of claim 14 wherein
wherein the first web page when rendered on a patient/consumer computer display of the patient/consumer computer by an internet browser computer program running on the patient/consumer computer, displays information concerning a plurality of scheduled communication sessions between the patient/consumer and a provider of medical services and/or goods, wherein each of the plurality of scheduled communication sessions is scheduled to occur at a future time.

16. The apparatus of claim 14 wherein
wherein the first web page when rendered on a patient/consumer computer display of the patient/consumer computer by an internet browser computer program running on the patient/consumer computer, displays a link for accessing a web page having a patient self assessment form, into which the patient/consumer can enter information concerning characteristics of the patient/consumer.

17. The apparatus of claim 16 wherein
the characteristics of the patient/consumer include the health history of the patient/consumer as recalled by the patient/consumer.

18. The apparatus of claim 14 wherein
wherein the first web page when rendered on a patient/consumer computer display of the patient/consumer computer by an internet browser computer program running on the patient/consumer computer, displays a link for accessing a web page having a provider quality survey form, into which the patient/consumer can enter information concerning the patient/consumer's opinions about the first provider of medical services and/or goods.

19. The apparatus of claim 14 wherein
the first server computer is programmed to provide a second web page having a list of selectable providers of medical services and/or goods; and
the first server computer is programmed to set up the first communication session between the first provider of medical services and/or goods in response, at least in part, to a selection by the patient/consumer using the computer interactive device of the patient/consumer computer, of the first provider of medical services and/or goods from the list of selectable providers of medical services and/or goods.

20. The apparatus of claim 14 further comprising the first server comuter is programmed to provide a second web page from the first server computer to the patient/consumer computer via the internet;
wherein the second web page when rendered on a patient/consumer computer display of the patient/consumer computer by an internet browser computer program running on the patient/consumer computer, provides information concerning the first communication session while the first communication session is taking place.
